(19) United States
(12) Patent Application Publication
(10) Pub. No.: US 2004/0133923 A1
(43) Pub. Date: Jul. 8, 2004

(54) Digital home movie library

(76) Inventors: Scott F. Watson, Santa Clarita, CA (US); Bruce Frazer, Los Angeles, CA (US)

Correspondence Address: GREENBERG TRAURIG LLP, 2450 COLORADO AVENUE, SUITE 400E, SANTA MONICA, CA, 90404, US

(21) Appl. No.: 10/646,192

(22) Filed: Aug. 21, 2003

Related U.S. Application Data
(60) Provisional application No. 60/405,157, filed on Aug. 21, 2002.

(51) Int. Cl. H04N 7/173; H04N 7/16

(52) U.S. Cl. 725/134; 725/142; 725/89; 725/87

(57) ABSTRACT

The system and method of the present invention provides viewers access to a library of movies, or any other audio/video content available for viewing at anytime. Specifically, the method involves transmitting movies wirelessly to a set-top box in one's home and allowing movies to accumulate. A hard disk drive in the set-top box is used to store movies. In an exemplary embodiment, movies are wirelessly transmitted to the set-top box using a datacasting technology which allows data to be encoded onto standard television signals and transmitted using existing television transmitters and broadcast towers. Movies are transferred to the set-top box using a broadcast file transfer protocol and stored on the hard drive. Movies are “packetized” and these packets are continuously transmitted to the set-top box where they are incrementally reassembled. The user is not aware of what data is being sent to their set-top box. The movies are pushed down by the provider to reside passively in the box for a finite time period. Transmission of the data is controlled by the content or service provider. To ensure that movies are received in their entirety, the same movie may be broadcast to the set-top box several times. Any packets of data that were not received in the first attempt of transmission will be received with subsequent broadcasts. The set-top box is also connected to a phone line for billing purposes.

### RELATED APPLICATIONS

This application claims priority to U.S. Provisional Patent Application No. 60/405,157 filed on Aug. 21, 2002, the contents of which are incorporated herein by reference in its entirety. The contents of this application is further related to U.S. patent application Ser. No. ______ (serial number not yet assigned) entitled “System for the Delivery and Dynamic Presentation of Large Media Assets over Bandwidth Constrained Networks” filed on Jul. 30, 2003, and U.S. Provisional Patent Application No. 60/403,995 filed on Aug. 17, 2002, the contents of which are incorporated by reference in their entirety.

### BACKGROUND

1. Field of the Invention

The present invention relates generally to video on demand. More specifically, the present invention relates to wirelessly transmitting a plurality of movies to a receiver for collection and subsequent viewing on demand by the user.

2. Description of the Background Art

There are currently many different ways of providing home viewers with video on-demand. One popular approach to providing on-demand video or movies commonly found in households is through Pay-per-view channels. Pay-per-view systems generally provide the home viewer with several television channels, each channel playing movies continuously/consecutively throughout the day. Often, a single movie is offered on more than one channel, such that the start time of the movie occurs more frequently, for example, every half hour. By staggering the start time of a movie across several channels, at any given time the user does not need to wait long until the next showing of the movie. The movies shown on pay-per-view channels are not available for viewing until the user actually selects to view the movie. The user is charged a fee and the movie is then made available for viewing.

Attempts have been made to create on-demand video systems more true to the title by streaming video directly to the user upon request. However, satellite networks generally do not have the bandwidth to support true on demand streaming of movies, while cable networks are very expensive to build. High levels of bandwidth are needed to support such transmissions of video on demand. Similar types of systems have been implemented by using computer networks which do offer higher bandwidth connections, however this is still not optimal since there is still a disconnect between computer networks and television.

It is therefore an object of the present invention to provide a method for providing movies on demand to home viewers that is cost effective, convenient and is provided in a responsive manner.

### SUMMARY OF THE INVENTION

The system and method of the present invention provides viewers access to a library of movies, or any other audio/video content available for viewing at anytime. Specifically, the method involves transmitting movies to a set-top box and allowing movies to accumulate. A hard disk drive in the set-top box is used to store movies. The movies are transmitted using a new datacasting technology which transmits large amounts of data over standard broadcast television signals. For example, in a 24-hour period, this datacasting technology can distribute 8-12 high-quality feature-length movies. The set top box is easily connected to a user's television just as any other external device such as a VCR or DVD player. The set-top box is also connected to a phone line for billing purposes.

Information related to the datacasting technology is found in U.S. Pat. No. 6,433,835 to Hartson et al. entitled “Expanded information capacity for existing communication transmission systems”, filed on Apr. 17, 1998, Published Patent Application No. US20030112370A1 entitled “Adaptive expanded information capacity for communications systems” and PCT Publication WO0215428 entitled “SPREAD SPECTRUM TRANSMISSION FOR EXPANDING INFORMATION CAPACITY IN EXISTING COMMUNICATION TRANSMISSION SYSTEMS” which are incorporated by reference herein in their entirety.

In an exemplary embodiment of the present invention, the set top box is located in a person's home, connected to their television using standard video cables. The set top box has an antenna which receives data via the broadcast television signal. The set top box has, preferably, at least an 80 Gigabyte hard drive for storing a plurality of movies. The set-top box has a modem which the set-top uses to periodically contact the service provider. Information passed between the service provider and the set-top via the modem includes, for example: the users “Viewing/Rental History” which is used for billing purposes, set-top performance logs which are used to monitor the performance of the system and “Movie Keys” which are used decrypt the movies. Though “Movie Keys” are transmitted over the modem, the telephone line and modem are not used for transmitting movie files themselves.

The set-top box has a processor which is capable of receiving the data stream from the broadcast signal, reassembling data, and writing data to the hard drive. The processor is also capable of simultaneously playing a movie and reacting to infrared signals from the remote control as well as modem activity. The hard drive is mated with the set-top box for security purposes, rendering it useless if removed and used anywhere else. The set-top box preferably does not have a fan as it is designed to be very quiet. The set top box also comprises a secure processor as part of its security system. The secure processor is the active component of a smart card which is physically attached to the PCB with epoxy to make it physically hard to tamper with.

The present invention is a system and method of providing on-demand viewing of movies or other media to viewers without the inconvenience of having to leave home. Movies are transmitted to the set-top box using a new datacasting technology which allows data to be encoded onto standard television signals and transmitted using existing television transmitters and broadcast towers. Movies are transferred to the set-top box using a broadcast file transfer protocol and stored on a hard drive. Movies are not “streamed” to the set-top box in real-time, instead content files are “packetized” and these packets are continuously transmitted to the set-top box where they are incrementally reassembled. The user is not aware of what data is being sent to their set-top box. The movies are pushed down by the provider to reside passively in the box for a finite time period. Transmission of the data is controlled by the content or service provider. To ensure that movies are received in their entirety, the same movie may be broadcast to the set-top box several times and the packets may be coded with forward error correcting (FEC) codes. Any packets of data that were not received in the first attempt of transmission will be received with subsequent broadcasts or reconstructed from received packets by using the FEC data.

The movies transmitted to the set top box are preferably newly released movies similar to those currently available at video rental stores. Once a full movie has been received by the set-top box, along with any other necessary information, the movie is added to a list of available movies on the set-top box and becomes viewable by the user. The present invention can be thought of as “Blockbuster™ in a Box.”

Movies transmitted to the set-top box also come with associated information that defines certain characteristics of the movie. This associated information is called metadata. For example, a movie may have an associated start and end date or time which limits the time period in which a movie can be viewed. A movie may arrive and be stored in the set-top box, however it may have a start date associated with it which does not allow it to be viewed until that date. This allows for any discrepancies in transmission times for movies that may vary from one location to another, and also allows for movies such as new releases to be “pre-loaded” and immediately available on the official release date. Similarly, the content provider may supply an end date associated with a movie, after which date the movie can no longer be viewed, and is automatically deleted from the set-top box.

Movies stored on the set top box are encrypted. Upon selection of a movie to view and satisfaction of business rules (ie: the user has sufficient credit), the set top box allows for the movie to be decrypted and played. The set-top box does not need to connect to the service provider prior to allowing a movie to be viewed, since the keys for decrypting the movies are typically pre-fetched and resident on the set-top along with the current account status. Obviously, the encrypted movies cannot be viewed without decrypting them. All decryption is logged and this log is used to determine a user's bill. The logic surrounding decryption and user account status is handled by the secure processor.

In a preferred embodiment of the present invention, a fee is charged to the user upon selection of the movie for viewing, a subsequent “rental confirmation” dialog and prior to viewing of the movie. In another embodiment of the present invention, the user is billed for viewing a movie once a substantial portion of the movie has been viewed. Once a movie has been selected, it can be viewed again without charge for a limited period of time (e.g. 24 hours), or for a limited number of viewings. In another embodiment, instead of paying for each movie, the user is charged a monthly fee. The amount of the monthly fee could depend on various options such as the number of movies that can be viewed, the period of time that a selected movie is available for viewing, and the number of permitted viewings of each selected movie. Thus, even though the user has a library of movies stored on the user's set-top box, there is no charge unless a movie is actually viewed.

The main menu of the user interface includes a window, inside which information about the set top box features and movie trailers play. This is also called the Barker Channel. For example, movie trailers for movies that are currently stored on the set top box are displayed in this window. Other content may include system features, helpful hints, or non-critical system alerts. This information is updated periodically, for example, based on content. The window which frames the video may preferably be highlighted, and selected. Once selected, the window expands to full screen view. Pressing any key on the remote control or front panel (with the exception of the “Play” controls) will minimize Screen once again and return the user to the Main Menu.

The “Barker Channel” is the video programming that runs when the user is on the Main Menu. The Barker Channel is an important part of the user experience, since viewing it will often “bookend” a movie rental. The Barker Channel functions as a multipurpose communications area serving as a way to add ‘life’ to the interface, it is the primary means for promoting content, and promoting the service.

The Barker Channel is composed of many individual video clips that are assembled on the fly to form a “show” or “channel”. The Barker Channel rarely gets a chance to run for very long since it is only displayed on the top-menu page and the user often navigates away quickly. If allowed to run, the Barker channel should ideally run for an hour or so before it starts to repeat itself. The Barker Channel can be selected and run in full-screen mode by the user.

The user interface of the present invention is a hierarchical scheme wherein movies are selected through different category lists. For example, movies may be sorted by genre, actors, or actresses, or rating. Each movie has “home page” where the trailer can be viewed as well as information about the movie such as what actors star in it, a brief summary of the story, etc.

In other embodiments of the present invention, data can be transmitted to the set-top box by cable, satellite, phone lines, or other internet connection, etc.

The present invention also employs a unique user navigation scheme. Instead of using a selection box or highlighted area to navigate around a screen or a list of choices, in some cases the selection box is kept stationary on the screen and the entire list or screen of choices is then moved or scrolled “underneath” it by the user in order to make selections. The selection box may be movable up or down for only a limited number of lines of a list before scrolling of the list begins. The navigation scheme is quite different from what is normally utilized and the results are visually appealing.

An advantage of the present invention over prior art methods is that it provides immediate access to a large number of movies for viewing in one's own home. The user does not need to request specific content, or indicate that content being broadcast to the set top box need to be stored. Content providers choose the content to be sent to the set top box, and the set top box automatically stores content that is sent to it.

There is no waiting until the “next showing” of a movie as is common with pay-per-view systems. The system and method of the present invention offers movies similar to those found in video and DVD rental stores, eliminates the trip to the store for each movie, and eliminates the possibility of being charged for late fees for returning a video/DVD late.

The attached descriptions of exemplary and anticipated embodiments of the invention have been presented for the purposes of illustration and description. They are not intended to be exhaustive or to limit the invention to the precise forms disclosed. Many modifications and variations are possible in light of the teachings herein.

### BRIEF DESCRIPTION OF THE DRAWINGS

FIG. 1 is an overall functional schematic of the present invention.

FIG. 1a is a detailed functional schematic of the asset management system in accordance with the present invention.

FIG. 1b is a schematic of the content preparation, encoding and encrypting aspects of the present invention.

FIG. 1c is a schematic of the conditional access system in accordance with the present invention.

FIG. 1d is a functional schematic of the billing, customer care, and back end system in accordance with the present invention.

FIG. 1e a functional schematic illustrating an exemplary content delivery system in accordance with the present invention.

FIG. 1f is a functional schematic illustrating aspects related to the set top box in accordance with the present invention.

FIG. 1g is a legend of the signals illustrated in FIGS. 1-1e.

FIG. 2 is a block diagram of the set top box hardware in accordance with the present invention.

FIG. 3 is an exemplary screen shot of the main menu.

FIG. 4 is an exemplary screen shot of a movie home page.

FIG. 5 is a block flow diagram representing an exemplary transition for typical operations from the main menu in the user interface.

### DESCRIPTION OF THE PREFERRED EMBODIMENTS

The system and method of the present invention provides viewers at home access to a library of movies, or any other audio/video content available for viewing at anytime. A set top box or other hardware device in accordance with the present invention is located in a person's home and connected to their television just as a DVD player or VCR would be connected. In an exemplary embodiment, movies are wirelessly transmitted to the set-top box using a datacasting technology which allows data to be encoded onto standard television signals and transmitted using existing television transmitters and broadcast towers. Movies are transferred to the set-top box using a broadcast file transfer protocol and stored on the hard drive. Movies are not streamed to the set-top box in real-time, instead content files are “packetized” and these packets are continuously transmitted to the set-top box where they are incrementally reassembled. The user is not aware of what data is being sent to their set-top box. The movies are pushed down by the provider to reside passively in the box for a finite time period. Transmission of the data is controlled by the content or service provider. To ensure that movies are received in their entirety, the same movie may be broadcast to the set-top box several times. Any packets of data that were not received in the first attempt of transmission will be received with subsequent broadcasts.

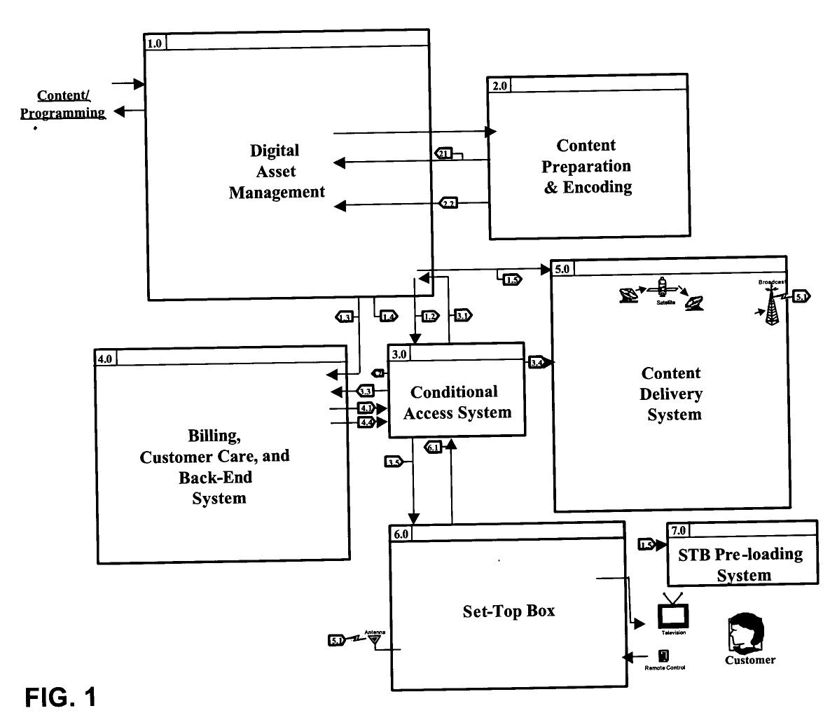

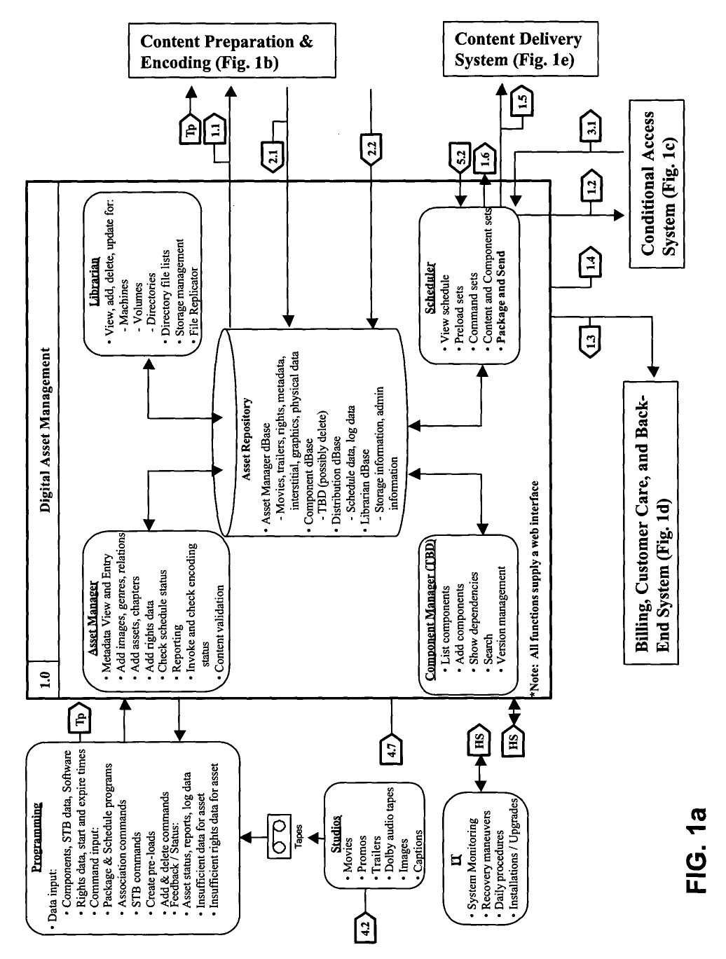

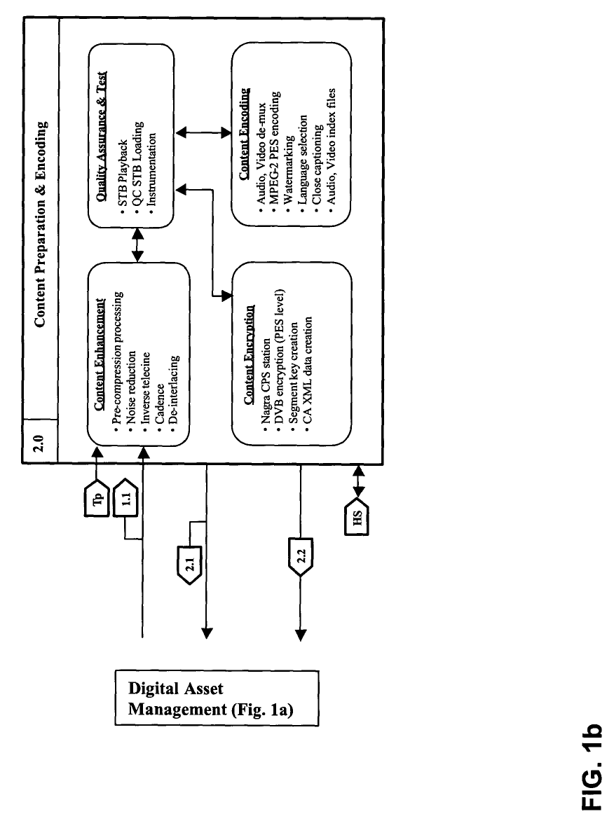

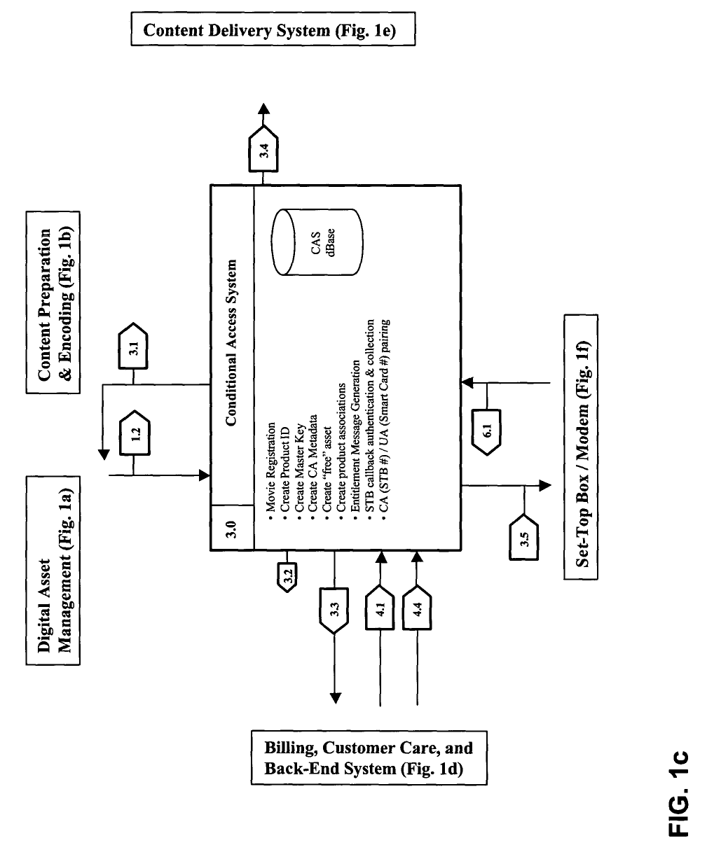

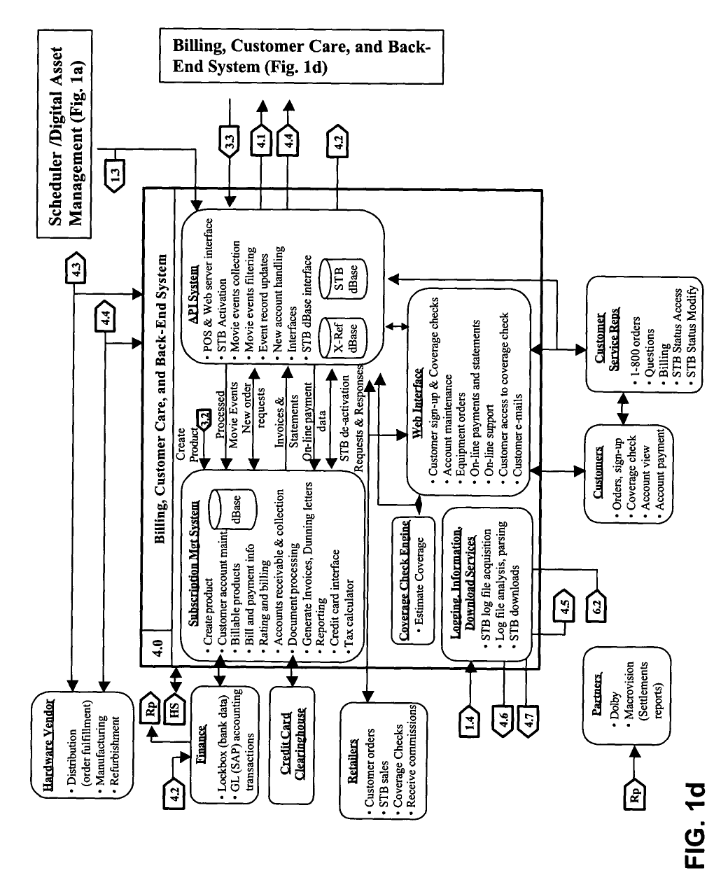

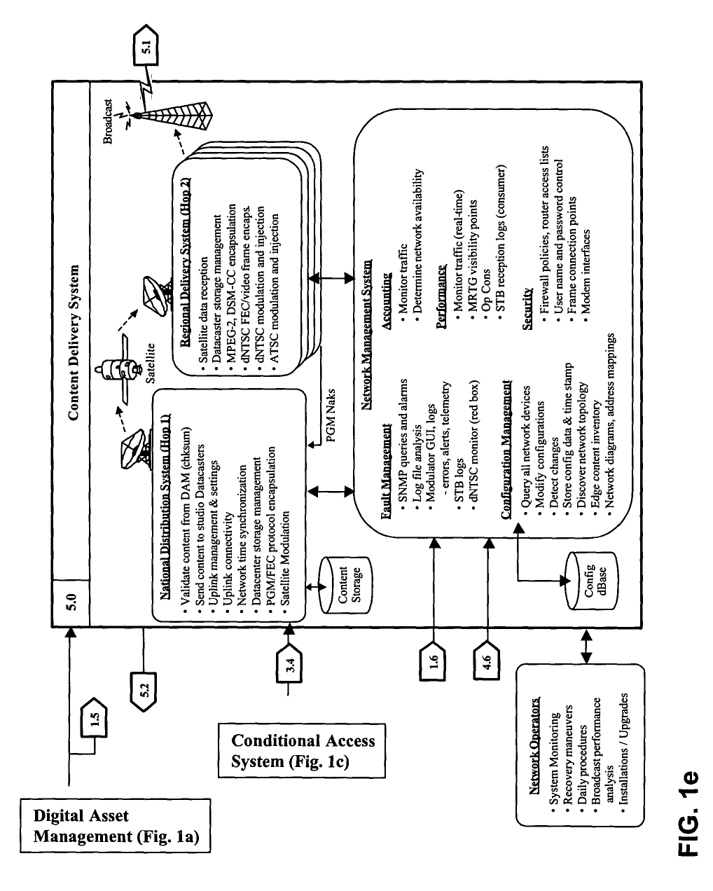

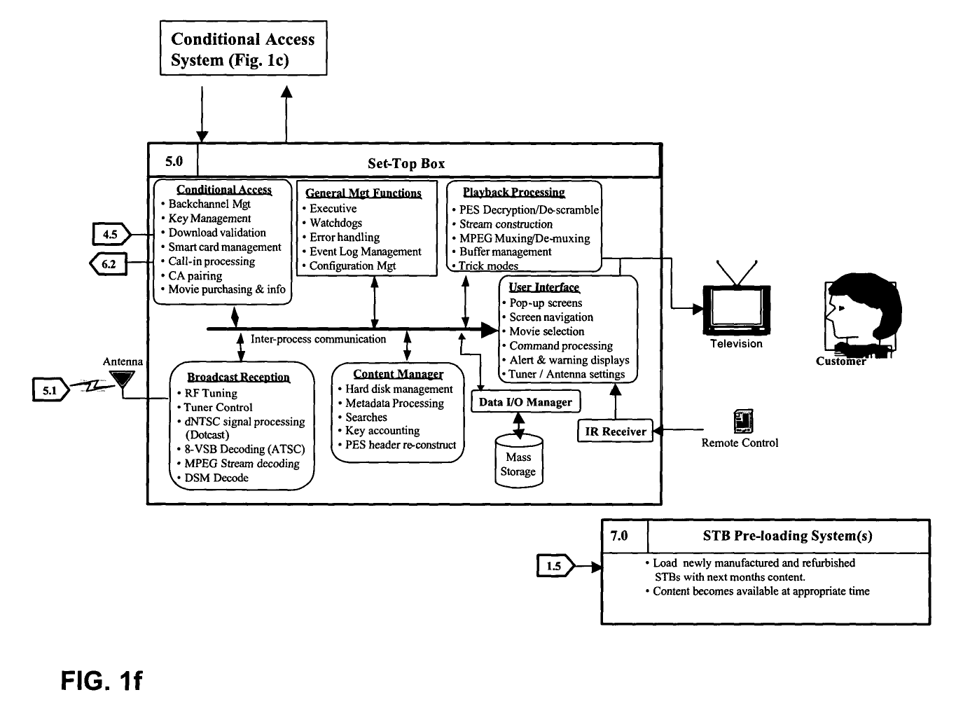

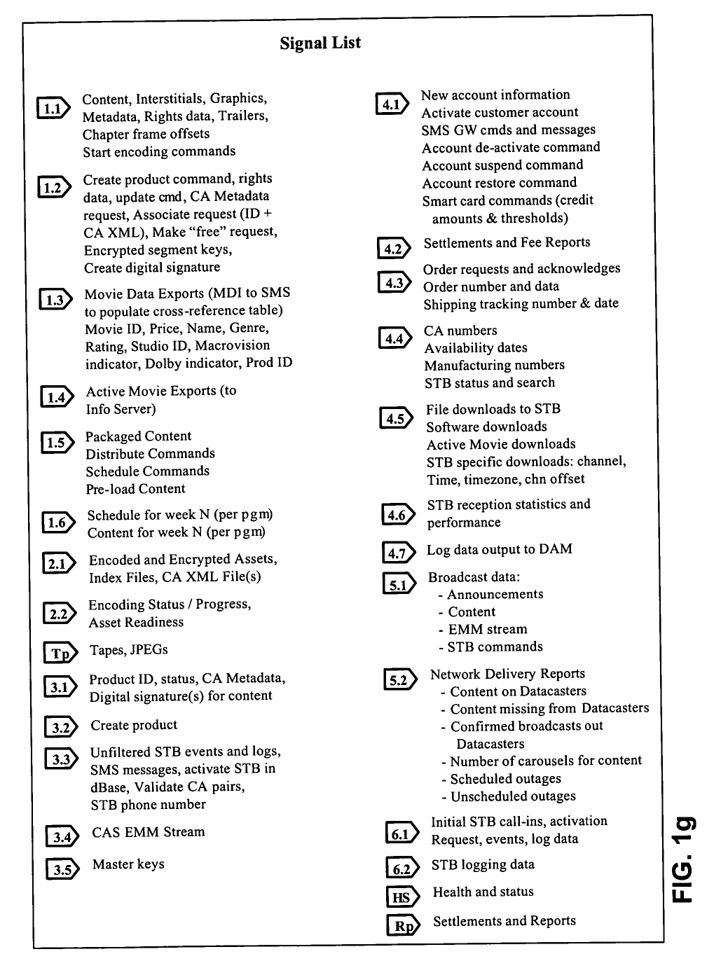

FIG. 1 is a functional schematic of the overall system and method of the present invention.

Content is provided by movie and television studios, for example. The content may be in the form of full length feature films, television shows, or other audio and video media. The content is distributed to the digital asset management system, where the content is stored in a large database, or asset repository. The digital asset management system is generally responsible for storing and organizing the data, as well as scheduling when the data is to be transmitted.

The content preparation and encoding system interacts with the digital asset management system and is responsible for encoding data, encrypting data, and testing data. Movies distributed to subscribers are encrypted, preferably MPEG-2 encoded and formatted as PES (Packetized Elementary Stream) files in separate audio and video files. For each movie, its content, metadata, promotional and other material is collected as a single movie product, or “movie data” that is managed and scheduled for distribution. The content preparation and encoding system is also responsible for preparing data to be broadcast. Once data has been prepared and properly encoded, it is sent back to the asset management system for storage.

The conditional access system is responsible for aspects of the present invention related to controlling access to data on the set top box. The conditional access system, for example, controls the encryption process, the creation of keys, the handling of “credit”, the provisioning of Smart Cards, enforcement of business rules and content decryption.

The billing, customer care, and back-end system is responsible for functions such as subscription management, billing, and customer support.

The content delivery system is responsible for delivering data to set top boxes. In an exemplary embodiment, the content delivery system utilizes datacasting to wirelessly broadcast the data. In other embodiments, wired communications lines may provide means for transmitting the data.

Finally, the set top box, generally located in a person's home, receives broadcast data from the content delivery system and communicates with the conditional access system in order to be granted access to the data.

1. Digital Asset Management

FIG. 1a illustrates the digital asset management aspects of the present invention in more detail.

Content providers such as movie and/or television studios provide media content such as movies, promos, trailers, audio, images, and captions. The studios may provide the media in the form of audio or video tapes, as well as other forms of media.

The Digital asset management system as illustrated in FIG. 1a comprises an asset manager, librarian, component manager, and scheduler which all interface with a large database, or asset repository.

At the core of the digital asset management system is the asset repository, which is responsible for storing content and other data to be sent to set top box. Within the asset repository there are several databases. The asset repository comprises an asset manager database which stores movies, trailers, rights, metadata, interstitial data, graphics, and other physical data. The asset manager database generally contains all content data, including entries for movies, actors and businesses and associated assets and metadata. It also contains rights data such as date ranges for assets and entities.

The distribution database contains content and component broadcast schedules, datacast distribution logs and set top box pre-load information. The library database generally contains storage information and administrative information. For example, the library database contains information on storage locations for cataloged files, including information on where files can be stored and where files are stored. It supports storage segregation by application defined “storage class.”

A number of things must be done to data when it is first received, such as generating and associating other data to the media, determining scheduling aspects, etc. For example, metadata is created for each movie. This may include scheduling information such as dates or times when to make a movie available for viewing, and how long it should remain available.

For example, movies have a contract begin date/time and a contract end date/time. ‘Contract’ dates are date/time range outside which content should not be displayed on the set top box. In the metadata, these dates are expressed in the contract period element. Metadata such as the contract dates need to be entered and associated with a movie prior to transmission.

Metadata also includes information about the movie, such as a short textual description, length of movie, genre, rating, actors, actresses, and director. Images such as a movie poster or still, actor or actress photos, are also created. Such images may be displayed in various locations of the user interface. Other types of metadata that are associated with a movie include information related to its price.

The movie content itself must also be altered before transmitting to the set top box. For example, a movie must be indexed into a number of chapters just as a DVD.

There are other types of data besides the movie itself. For example, movies are generally sent along with a movie trailer. A trailer is this context refers to movie specific audio/visual promotional material, delivered with the movie. The trailer is generally free for the viewer to watch. In the metadata XML, trailers are expressed in the TRAILER element. Trailers also have a contract begin date/time and contract end date/time. Trailer contract dates are not necessarily tied to contract dates of associated movie.

Trailers are part of the movie data, or product—as represented in the metadata. This product has a single key that generally should not be deleted. The Trailer product may be changed. The change is reflected by a new Product Id, Item Id pair in the metadata and will require a new key. The old key should be deleted once no trailers reference it.

Interstitial data is another type of data that is transmitted to the set top box. Interstitial data is this context refers to content not delivered with a movie, which is intended for use, for example, in the Barker Channel. In the metadata, interstitials are expressed in the INTERSTITIAL element. Interstitial data may have a contract begin date/time and contract end date/time. On delete of interstitial must also delete db entries, video, audio, indexes, etc. Net effect on total disk space used after movie arrival and deletion should be 0.

Software data, including software updates to the set top box, is another type of data that can be broadcast.

The Asset Manager is responsible for many such tasks, such as metadata entry, adding images, genres, and relations, assets, chapters, and rights data. The asset manager also performs tasks such as checking the schedule status, reporting, invoking and checking the encoding status, and content validation.

2. Content Preparation and Encoding

The asset repository sends and receives data to a content preparation and encoding system. The content preparation and encoding system is illustrated in greater detail in FIG. 1b. Generally, movie data that is transmitted to the set top box is compressed and encrypted. The content preparation and encoding system is responsible for preparing, encoding, encrypting, and testing data. Data is first sent for content enhancement, where the data is processed for pre-compression, noise reduction, inverse telecine, cadence, and de-interlacing. The content is then encoded and tested for proper playback.

In an exemplary embodiment of the present invention, a movie is distributed as a set of encrypted MPEG files and a compressed tar file. The MPEG files are encrypted audio and video files for the movie and its trailer. In general, the files conform to ISO/IEC 13818 (MPEG-II) standards, but many of the specific details may differ. The tar file is a collection of assets including the titling script, MPEG indices, images, metadata and a metadata XML file. The metadata XML file is essentially a manifest which includes movie metadata and information about all other files.

The audio and video portions of the movie are transmitted in separate files. This allows multiple language audio tracks to be supported without wasting space on the set top box hard drive. In a conventional system, both the audio and video are multiplexed into a single program stream. However, in order to support multiple languages, this would require either substantially larger files containing all the alternate languages (like on a DVD) or totally separate program stream files for each language, thus wasting huge amounts of bandwidth. Therefore, the set top box contains software to prompt the user to pick a desired language at reception time. This assumes that movies are available with multiple foreign audio tracks but the video portion is the same.

Therefore, one of the steps that occurs during the content encoding is demultiplexing the audio video signal into two discrete audio and video signals.

The audio and video data is preferably encoded in MPEG Packetized Elementary Stream (PES) format. Raw Elementary Stream (ES) or Transport Stream (TS) could alternatively be used. Although TS is commonly used it has a size overhead, relative to PES and ES that is not optimal for the present application. Conversely, ES has the lowest byte overhead, but it is possible that reception errors in the data stream could cause audio and video to lose synchronization. This is because there is no higher level “framing” information in ES. Therefore, there is no way of knowing if a frame is lost. Commonly, PES packets are 4 k in size (DVD), however significantly larger packets may be used in the present application to decrease the byte overhead of PES headers.

The video bit rate is typically highly variable. In general, it is expected for the average video bit rate of movies to be between 1.2 Mbps and 1.4 Mbps. In very simple scenes this average may fall to 300 kbps, and in action scenes could reach as high as 5 Mbps.

The video stream may preferably contain very large groups of pictures (GOP)s. A Group Of Pictures (GOP) consists of all the pictures that follow a GOP header before another GOP header. Typically a new GOP begins every few frames, or when a scene change occurs. The motivation for using very large GOP's is that I-pictures are very large. An I-picture, or Intra-picture is the first picture after the GOP header. Hence reducing the number of I-pictures in a movie will reduce the size of the movie file. When there are many frames between I-frames, it is crucial that the MPEG encoder caretully controls the amount of error it allows to accumulate.

However, many implementations of “trick play” require frequent I-frames and may affect fast forward, rewind, and seeking/resuming from arbitrary locations.

In a majority of the cases, the MPEG video streams will be 23.976 frames per second (aka 24 fps), with progressive (frame) encoding. The bit stream will be flagged to play back with 3-2 pulldown on standard television sets. There may be some content which cannot use progressive frames. For example, Video sourced material, and trailers that have been edited with a video editor. In these cases we will use 29.98 fps interlaced encoding at a higher bit-rate. The object is to provide the best visual quality with the smallest files.

In one embodiment, audio will be encoded using two discrete channels (stereo) from a four channel Dolby Surround source. Alternatively, AC3 audio (Dolby Digital™) will be supplied for some films, but AC3 files are larger than the discreet stereo files, so they are only supplied for a subset of movies in order to minimize disk usage.

After data has been properly encoded, and tested again for playback, data is sent for encryption. A combination of well-known cryptographic algorithms are used, such as RSA and 3DES.

Once data has been encoded, encrypted, and tested for quality assurance, it is returned to the asset management system in the form of encoded and encrypted assets, index files, and XML files for storage.

The scheduler is then responsible for packaging and sending data to the content delivery system. Before data can be sent to the content delivery system, however before data can be sent to the content delivery system, conditional access data must be generated.

3. Conditional Access System

FIG. 1c illustrates the backend portion of the conditional access system aspects of the present invention in greater detail.

Conditional access is the mechanism for securing the set top box from unauthorized access to its contents.

The Conditional Access System is responsible for movie registration, creating product ID, master key, metadata, product associations, entitlement message generation, set top box callback authentication and collection, and CA set top box #/Smart Card # pairing.

4. Billing, Customer Care, and Back End System

The billing, customer care, and back-end system is responsible for activating newly purchased set top boxes, setting up accounts, billing and payment, as well as customer support.

The set top box periodically communicates log information and other information for billing purposes. The billing system handles this data and charges the customer accordingly.

The billing, customer care, and back end system is illustrated in greater detail in FIG. 1d.

5. Content Delivery System

FIG. 1e illustrates the Content Delivery System aspects of the present invention in more detail.

The datacasting technology (as described in U.S. Pat. No. 6,433,835 which is incorporated by reference herein in its entirety) is capable of delivering massive amounts of content. For example, in one 24-hour period, using one broadcast channel, the datacasting technology can distribute 12 DVD-like feature-length movies; or 240 hours of CD-quality mp3 music, or video games, e-books and software applications. In fact the datacasting technology can deliver digital quality movies to home storage and viewing appliances far faster than Hollywood can make them.

The datacasting technology works by creating a digital sub-carrier about the visual and audio carriers of terrestrially broadcast television signals. Data is encoded into the sidebands. Similar datacasting techniques can be used with cable and satellite television signals as well. Therefore it is anticipated that data can alternatively be broadcast by using a sub-carrier of cable or satellite television signals. Data is preferably broadcast using this datacasting technology, however data can also be transmitted to the set top box using a number of different methods.

Movies are transferred to the set-top box using a broadcast file transfer protocol and automatically stored on the hard drive. Movies are distributed as a set of encrypted MPEG files and a compressed tar file. Movies are not “streamed” to the set-top box in real-time, instead content files are “packetized” and these packets are continuously transmitted to the set-top box where they are incrementally reassembled. The user is not aware of what data is being sent to their set-top box. The movies are pushed down by the provider to reside passively in the box for a finite time period. Transmission of the data is controlled by the content or service provider.

To ensure that movies are received in their entirety, the same movie may be broadcast to the set-top box several times. Any packets of data that were not received in the first attempt of transmission will be received with subsequent broadcasts.

A movie may should not show up in the user interface until the tar file is complete and has no data errors, and the movie MPEG files for the movie's video and the preferred audio language have less than the maximum acceptable errors.

6. Set-Top Box

A. Description of Hardware

Each set top box is preferably capable of storing approximately 100 movies or more on its hard disk drive (HDD), along with related movie trailers and promotions. The actual movie content on the hard disk drive is turned over periodically, as scheduled by the digital asset manager. Movie products are promoted with a Barker channel, which is a running set of videos seen while the user is on the user interface (UI) main menu, showing what products are available. The user can search through stored movies using several selectable filters. The user rents movies of choice and views them for some limited time. Decryption keys are sent to the set top box over a Public-Service Telephone Network (PSTN) back-channel when the set top box's conditional access (CA) software periodically calls in. The back-channel will also be used to collect rental and other subscriber information by communication with the Subscriber Management System (SMS).

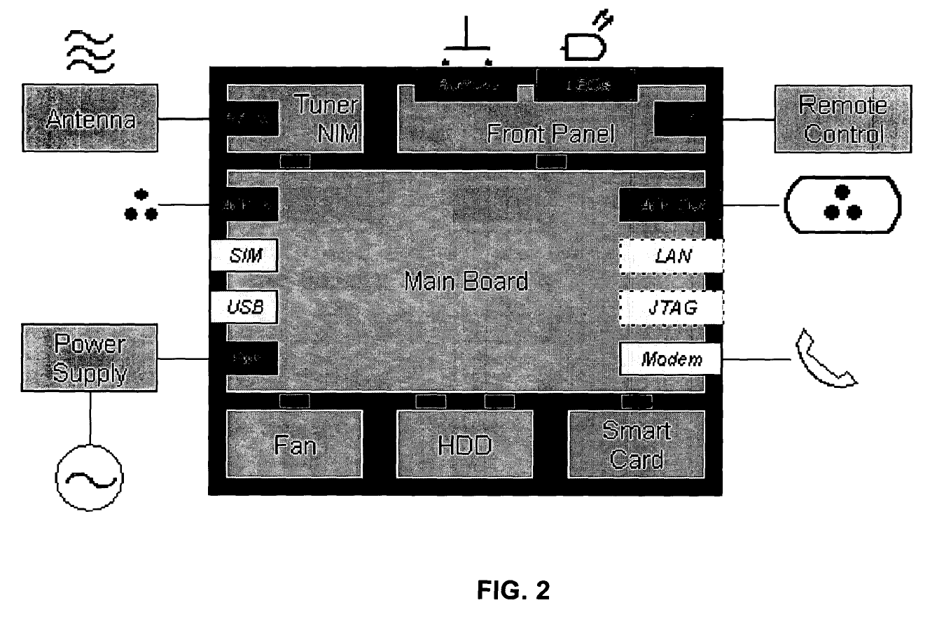

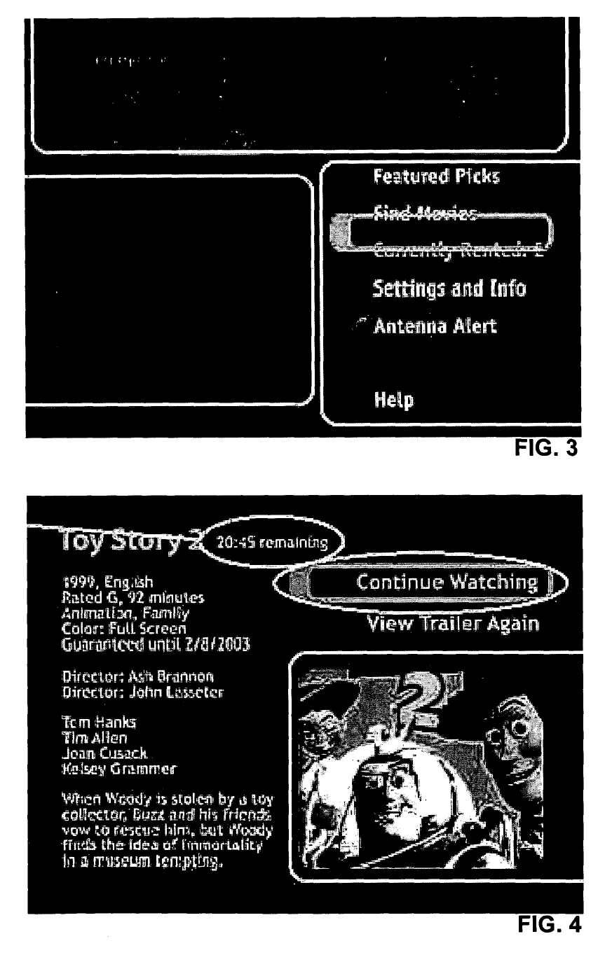

An exemplary embodiment of the set top box hardware is illustrated in FIG. 2. In an exemplary embodiment of the present invention, key components for the set-top box include:

integrated set-top Integrated Controller with Power PC host, dual MPEG-2 transport stream demultiplexer and MPEG-2 A/V decoders

ATSC and dNTSC receiver/demodulators

S-Video and RCA video input and output connectors, with stereo and S/PDIF audio, all with pass-through signal functions when the set top box is in standby mode

160 GB hard disk drive with secure IDE interface

ISO modem for back-channel connectivity

USB port

Smart card interfaces (internal and external)

Front panel manual button and IR Remote Controls

Real-time clock with trickle charged power

Thermistor for monitoring and self-cooling (with Fan)

2 MB Flash memory, secured with encryption and secure boot process

128 MB SDRAM for run-time software execution

JTAG, Ethernet and Serial ports for development (removed in production)

There are also various external and internal interfaces for the set top box. In an exemplary embodiment, the external interfaces for the set top box include:

Antenna (input), for reception of ATSC and dNTSC RF signals

Audio and Video (input), for in-line installation of the set top box between a User's video source and television

Power Supply (input)

Smart Card (input/output), for a secondary card that is inserted into the set top box

Front Panel Buttons (input), used for some User Interface functionality

Remote Control (input), used for the User Interface

Audio and Video (output), for output to a User's television

Modem (input/output)

Front Panel LEDs (output), for general indication of set top box status

USB (input/output), for future use

Ethernet, Serial and JTAG (input/output), for engineering development only

More generally, the set top box has a communications means through which data is received to the set top box. In an exemplary embodiment, the communications means comprises an antenna which receives data via the terrestrially broadcast television signal. In an exemplary embodiment, the antenna is an external active antenna that will provide RF reception of ATSC and dNTSC signals. Since the antenna generally only receives data, it may be coupled with a modem for periodic outbound communication. The modem is used to periodically contact the service provider. The modem is preferably an analog modem capable of at least 28.8 kbps. In other embodiments however, the communications means may include a wired data connection, such as ethernet, USB, cable, or satellite connection. Similarly, the modem is not required for outbound communication. Outbound communication could be through the same inbound communication channel, such as wireless or wired internet connection. For example, the set top box may allow a user's internet connection to be used for outbound communication instead of the modem and phone line by using a USB port on the set top box. Likewise, the set top box could come with an Ethernet port.

The set-top box has a processor which is capable of receiving the data stream from the broadcast signal, reassembling data, writing data to the hard drive, as well as simultaneously playing a movie and reacting to infrared signals from the remote control as well as modem activity. For example, the CPU should be capable of receiving the 5 Mbps data stream via serial MPEG transport stream, reassembling and writing transmitted files to disk, and simultaneously controlling the playback of a 6 Mbps movie. The CPU should be capable of simultaneously reacting to IR control events and Modem activity.

In an exemplary embodiment, there may be two processors in the set top box. For example, one is a host processor, and the other is a microcontroller. The host processor executes software that initiates reception and demodulation of the appropriate ATSC/dNTSC signals, stores files, including movie data, on the hard drive, provides a graphical user interface, performs decryption of movie content and other conditional access functions, initiates and controls playback of movie content, with interactive features, and communicates with the SMS for rental agreement and logging. The microcontroller is used to interface with the front panel and remote control.

Security in the set top box is important for movie product copyrights. Generally, movie products are encrypted using methods at the MPEG PES level. Further protection is provided with an encrypted interface with the hard disk drive. More protection is provided by encryption of run-time software that is checked and decrypted upon set top box initialization.

The set top box has storage means such as a hard disk drive for storing data received through the broadcast signal. The hard drive is preferably “mated” to the set-top box, rendering it useless anywhere else. The hard disk drive firmware preferably supports a security scheme that will render the hard drive useless in other than the set top box. The hard drive motor should support power on/off under software control.

In an exemplary embodiment, the set top box will begin power-up initialization by loading and executing boot code that resides in Flash memory. Flash memory is protected so that set top box encryption keys and the boot code cannot be changed once the set top box leaves the factory. This way, new software cannot be stored in the Flash that might be able to by-pass the normal boot code. There shall be a boot block section for each Flash that is not programmable after lockout at the factory.

A combination of well-known cryptographic algorithms are used, such as RSA and 3DES. Public and private key lengths are preferably at least 1024 bits.

The set top box also comprises a secure processor as part of its security system. The secure processor is the active component (the embedded microchip) of a smart card which is physically attached to the circuit board with epoxy to make it physically hard to tamper with. A smart card is a plastic card about the size of a credit card, with an embedded microchip that can be loaded with data and other applications.

The secure processor is used for stored value, client certificates and processing ‘segment keys’. The video stream is not passed though the smart card. The smart card will be installed internal to the chassis onto the main board and connected to a smart card controller. The smart card shall be inserted into its connector and epoxy applied so the card may not be removed intact.

A provision for a second smart card, one that is external to the set top box, is also made. The external unpopulated smart card slot will also be provided to support a field upgrade of security hardware should the system become compromised.

The Tuner Network Interface Module (NIM) provides a front-end for the set top box in order to receive ATSC and dNTSC signals. When the desired broadcast channel is ATSC, the Tuner NIM provides all functionality required for demodulation, and outputs a digital MPEG Transport Stream (TS) directly to a MPEG demultiplexer on the Main Board. If the desired broadcast channel is dNTSC, a ReX ASIC is used in conjunction with the tuner NIM to ultimately provide an MPEG TS.

In order to facilitate the move to digital television (DTV), the set top box may preferably include hardware to receive data via 8-VSB DTV. It is not necessary for implementation to support simultaneous DTV and dNTSC reception. The set top box will not decode the ATSC MPEG video stream; it will only use the data part of the DTV stream. Ideally, the ATSC demodulator should have QPSK capability for cable system compatibility.

The video subsystem preferably comprises an MPEG-2 decoder with scaling and translation, capable of MPEG-2 video rates from 0.7 Mbps-6 Mbps. The video subsystem should also support vertical blanking interval (VBI) closed captioning and sub-titles.

The set top box preferably also includes a Macrovision enabled digital-analog converter chip which prevents copying of data onto videotapes, DVDs, CD-ROMs, or other media. The Macrovision chip applies copy protection to the analog output of the set top box. This allows for transparent viewing of the original data, but causes copies made on most VCRs to be substantially degraded.

The set top box in accordance with the present invention is preferably only powered down by unplugging the box or disconnecting the unit from the power completely. This ensures that the unit receives movies through the broadcast signal at all times. In some embodiments, however, the user is provided with a “power” control function, for example, on the front panel of the set tope box and the remote control which places the unit into a “standby” mode. When the unit is placed in standby mode, all audio and video input signals shall be pass-through to their corresponding output interfaces with no cross-conversions; i.e. the composite video input signal is pass-through to composite video output.

A watchdog timer will be incorporated into the set top box of the present invention. All software tasks in the system must respond to a watchdog message from a watchdog task. Upon the reception of a watchdog message, a task must send acknowledgment messages to the watchdog task. The watchdog time or is connected to the CPUs external reset line. In case any software tasks stop responding to the watchdog timer (system hangs) for any reason, the watchdog will cause the set top box to reboot. Any known information (e.g. time that task IDE) about the watchdog reset event should be logged.

Removal of power to the set top box must not corrupt or result in loss of data unrelated to the data currently being written to. The file system must be capable of recovering from a power failure, particularly during a disk write, without any serious damage to the file system itself. File system error correction must be quick. The recovery time should, for example, be less than 20 seconds. The file system must also be capable of reading to separate files such as video and audio for playback at a sustained data rate of around 9 mbps (peak) for video and 384 kbps (peak) for audio while simultaneously writing single file (storage of a new movie) at a sustained data rate of about 20 mbps (ATSC).

Therefore, a transactional or “journaled” file-system is preferred. The application and it's back up copies should be in “read-only” partitions that are very unlikely to suffer corruption. The applications and/or operating system must be “field upgradeable” either via the datacast or modem. Multiple versions and backups of the application should be retained. The client should rollback to a previous version if it detects more than a critical number of Watchdog instigated resets.

The set-top should be very quiet (ie: no louder than 30 dB SPL measured at 1 meter) during normal operation, which includes hard drive seeking while assets are played or being received. Set-top must work when stacked on or between other A/V equipment. It is preferred that the set-top not require a fan. If a fan is required, then a variable speed fan is specified.

The set top box also preferably comes with a simple remote control. Buttons include: up, down, left, right, select, menu, forward, rewind, pause, play, skip forward, and skip back. The remote control also has a “Power” (pass-through select) button, however the power button does not actually power down the unit.

The set top box can preferably be operated from the front panel. The front panel has navigation arrows, a select key and a menu key. A display is not required.

The set top box is connected to the user's television just as any normal external device, such as a DVD player or VCR. In a preferred embodiment, the set top box has the following inputs: telephone (RJ-11), F-Type Connector for Antenna (not a pass-though), IR Receiver, Smart card slot, USB for future expansion, Base-band A/V Pass-though (pass-through option), Composite Video (RCA), S-Video, and RCA Audio.

The set top box should have standard video outputs such as Composite Video (RCA connector), S-Video Output. It is preferred that both Composite and S-Video outputs can be active simultaneously. If only one can be functional then the selector will be external and adjacent to the video connectors. The set top box should also have standard audio outputs such as Stereo Out (RCA connectors).

The set top box preferably comes with a full hard drive of preloaded content.

B. Functional Description

FIG. 1f illustrates the set top box of the present invention in greater detail. The set top box can be functionally divided into conditional access, general management functions, playback processing, broadcast reception, content manager, and user interface.

Conditional Access

An important component of the set top box of the present invention is the conditional access system.

The Conditional Access System component of the set top box is responsible for conditionally decrypting the content when the business criteria are met.

The conditional access system preferably utilizes the modem to dial out to fetch keys in order to decrypt movies.

Playback Processing

In general, the set top box plays movie files (audio and video) that conform to ISO/IEC 13818 (MPEG-II) specifications. The set top box stores audio and video portions of the movie as separate files in the encrypted PES format. Movie files need to be re-assembled from PES format into a transport stream as well as the separate audio and video tracks multiplexed together prior to playback. Files must also be decrypted before playback. In order for a movie to be decrypted, its decryption key must be obtained.

The Playback Manager is primarily responsible for keeping data flowing during the playback process. The Playback Manager monitors the AN rate buffers and keeps them full by fetching data from the hard drive buffers. The playback manager also orchestrates the entire playback and trick-play process from startup to shutdown.

The Playback Manager performs the following functions:

Allocate, initialize, and setup the Integrated Controller (PVR) buffer

Pre-fill transport stream (PVR) buffer until rate buffers are full (wrap data with TS header)

Monitor and keep rate buffers full during playback by writing AN data with TS headers in TS buffer

Control/setup “trick play”: forward, reverse, pause, and frame advance

Start/stop A/V decoders via hardware drivers

The Playback Manager interacts with the following other software modules:

Data I/O Manager

MPEG Audio Decoder

MPEG Video Decoder

Transport Control

Conditional Access

User Interface

Interrupt Service Module

Movie Playback

During playback, the application software must retrieve audio and video data from the hard drive and direct it to the integrated controller chip's demultiplexer input. During this process, the application software should also be able to simultaneously store files for a second movie on the hard drive. The application software must be able to sustain data flow in both directions (reading and writing to the hard drive) without letting the integrated controller chip's AV rate buffers become empty. The AN rate buffers must also be prevented from becoming full because it will stall the transport input. Decryption key data must also be retrieved from the conditional access module and loaded into the integrated controller's descrambler.

In order for the Playback Manager to play a movie, the following pre-conditions must exist:

The movie “master key” must exist and be accessible

The movie has been purchased by the user

The video file must exist

The set top box should support MPEG-1 layers 2 and 3 audio formats. The set top box should support AC3 audio.

The set top box should be able to playback movies with certain number of errors. The following types of errors must be handled: transmission induced random errors, including single bit errors, arbitrarily large runs of consecutive errors.

The set top box should play at least the following combinations of horizontal and vertical resolutions: Horizontal: 720, 640, 544, 480, and 352. Vertical: 480, 240. The set top box also supports playback with 3:2 pulldown on standard television sets when playing 23.976 full frame source. The set top box must also correctly play 29.976 interlaced content.

The set top box should correctly play different aspect ratio movies on both 4:3 and 16:9 monitors, including sending the appropriate WSS signals. A 4:3 movie must play full-screen on 4:3 movie and television chosen mode on wide screen TV. 16:9 anamorphic (widescreen) movie must play letterboxed on a 4:3 TV and and without letterboxing on 16:9 (wide screen) TV.

The set top box must provide chapter skipping like in a DVD player. The set top box must provide trick play functionality, including fast-forward, fast-rewind, pause and single frame forward and back. The set top box supports MPEG-II bit rates from 0.1 mbps to 9 mbps.

The set top box supports VBI closed captioning. The closed captioning data is contained in a single data file. The playback manager reads this data into memory when playback begins. The set top box should also support subtitling via the on screen display mechanism for movie playback.

Broadcast Reception

Since data is preferably transmitted to the set top box through standard television broadcast frequencies, an antenna is provided for reception of ATSC and dNTSC RF signals. A tuner provides a front-end for the set top box in order to receive ATSC and dNTSC signals. The tuner provides all functionality required for demodulation, and outputs a digital MPEG Transport Stream (TS) directly to a MPEG demultiplexer.

The set top box should be able to receive data at a sustained rate of 4 mbps, and a maximum rate of 20 mbps.

Managing Content on the Set Top Box

Metadata governs many aspects related to the content on the set top box. The metadata defines many of the rules by which content on the set top box is managed. For example, a movie may have an associated start and end date or time which limits the time period during which a movie can be viewed. A movie may arrive and be stored in the set-top box, however it may have a start date associated with it which does not allow it to be viewed until a later date. This allows for any discrepancies in transmission times for movies that may vary from one location to another, and also allows for movies such as new releases to be “pre-loaded” and immediately available on the official release date. Similarly, the content provider may specify an end date associated with a movie, after which date the movie can no longer be viewed, and is automatically deleted from the set-top box.

Metadata also includes informational data about a movie. For example, metadata includes information such as a brief description of the movie, its genre, rating, actors and actresses found in the movie, director, duration, etc. This informational data is supplied to the user interface for the user.

Metadata Processing

The set top box is therefore capable of processing and storing metadata. A content database with indexes and links to frequently accessed data groups is maintained to enable quick searches into metadata. The set top box must determine if a movie is complete and update the content database.

Metadata is set out in XML tag format and generally transmitted in a single XML document. A main metadata element is to specify the type of data being delivered, such as “product”, “interstitial”, “software” or “data”.

A product, for example, is a collection of content that is sold as a unit. A movie and its related trailers or other content may be considered a product. A product may also specify a class of free content, such as movie trailers and interstitials. For each product, there is metadata included to indicate the price, or the amount the customer will be charged for the product. Free products will have a price of “0”.

Interstitial data is data that is played in the ‘barker channel’. Within the interstitial tag there may be other tag identifiers. For example, the GRADE attribute is a general value for the interstitial. This grade may be used when determining what content to delete. The RATING attribute is the MPM rating. The CLIP_TYPE attribute indicates the type of interstitial clip. For example, supported values include OPENING, PROMO, BRANDING, TRAILERINTRO and MOVIENEWS. The DURATION attribute is the interstitial duration in seconds. The COLOR_FORMAT is one of: black and white, color, or colorized. The WIDESCREEN attribute indicates whether or not the interstitial is in wide screen format (assume not).

Software is yet another data type that has its own types of metadata associated with it. New software images are periodically broadcast to the set top box for subsequent installation. The application must be sent in a way such that it can be verified to be authentic and unmodified. It will also most likely be wrapped in metadata including revision number, who it is targeted to, how urgent it is, etc.

Therefore, the SOFTWARE tag specifies a software package. The SOFTWARE_ID attribute is a unique identifier for the software. Software should only be installed if the hardware platform matches the existing platform and the hardware version is at or higher than current requirement. Software may replace the entire set top box application, or only replace individual software components.

The software version number is also specified in the metadata. If a software release is received via broadcast, the release should only be installed if the family matches the existing software and version is greater than the existing version. There is also a metadata tag that identifies a minimum required version for the set top box hardware. For example, if the set top box is not running the identified version or a later version on the identified platform then the package should be ignored and removed. The PLATFORM attribute identifies the hardware platform to which this requirement applies.

Movies are another type of data. Generally speaking, movie data comprises audio and/or video files that make up a movie as well as associated data such as metadata. Movie metadata elements consist of, for example, movie ID, grade, rating, default feature, duration, coloration, macrovision, widescreen, and keep until date. The MOVIE_ID attribute is a unique identifier for the movie. The GRADE attribute is a general value for the movie to be used when determining what content to delete. Possible values are A, B and C. The RATING attribute is the MPM rating. The DEFAULT FEATURE attributes indicates whether or not the movie should be used as a default featured movie in the case where there are not enough movies within their FEATURE PERIOD. The DURATION attribute is the movie duration in seconds. The COLOR FORMAT is one of: BLACK_AND_WHITE, COLOR or COLORIZED. The MACROVISION attribute indicates whether not Macrovision should be enabled when playing the movie. The WIDESCREEN attribute indicates whether or not movie is in wide screen format. The KEEPUNTIL attribute is date until which the movie should not be considered for deletion. This date should be ignored if it is after the ending contract or schedule date. The <TRAILER> tag describes a trailer for a movie.

Other metadata elements associated with a movie include person, which describes a person who has a role in a movie, such as an actor, actress, or director. The PERSON_ID attribute is a unique identifier for the person. This should be used to link people across movies so that lists of movies for a person can be displayed. The ROLE attribute indicates the role the person played in the movie. Supported values are ACTOR and DIRECTOR.

The LANGUAGE attribute indicates the language for an audio or close captioning file. The set top box preferably retains the audio files of the movie based on the user selected language(s). The set top box should filter audio files for desired languages at reception time. The set top box may receive audio files for many different languages, but only keep the audio file for the user's selected language.

The ENCODING_FORMAT attribute contains additional format info about the content. For audio content the value may be “STEREO” or “DOLBY 5.1”. “STEREO” means MPEG audio. “DOLBY 5.1” means Dolby 5.1 (sometimes referred to as AC3).

Other metadata elements include: the IMAGE tag which describes an image that can be displayed in the UI, the width and height tags, which specify the image width and height, and the UNITS attribute which identifies the units that WIDTH and HEIGHT are in. For example, units may be in pixels.

Other metadata tags indicates that parent element describes an audio asset, a video asset, or a titling asset (for use in closed captioning).

Making Movies Available

Movies may have a contract begin date/time and contract end date/time. ‘Contract’ Dates are date/time range outside which content must not be displayed on the set top box., and are specified in the metadata. Contract dates are optional for some content. When not specified for such content, the content may be shown without date constraint.

A movie is not viewable before the contract begin date or after contract end date. A movie may not rented less than 24 hours before contract end date. Movie is ‘guaranteed’ to be available until ‘Keep Until’ date. Keep Until’ Date: Date until which the content should not be considered for deletion. Only applies to Movie content. Also referred to as the ‘Guarantee’ Date.

The <CONTRACT_PERIOD> tag contains a date range outside which the parent element may not be viewed/played on the set top box. If the tag is not present then there are no date constraints for viewing of the item. The BEGIN attribute is begin date/time at which the parent element may be viewed/played. TIMEZONE is standard 3 character time zone designation. Default is GMT. Default time is midnight. Seconds is assumed to be 0. The END attribute is end date/time at which point the parent element may no longer be viewed/played.

The <FEATURE_PERIOD> tag contains a date range inside which the parent element should be a “featured pick”. Featured picks are the movies that are displayed across the scrolling marquee. For example, newly released movies may be considered featured picks. Note that FEATURE_PERIOD should only be used to select featured picks if enough movies are within their FEATURE_PERIOD, otherwise the DEFAULT_FEATURE attribute should be used. The BEGIN attribute is the beginning date (inclusive) of the feature period. The END attribute is ending date (inclusive) of the feature period.

The <RELEASE_DATE> tag contains the release date of the movie. The release date may be used for informational purposes to the user. Alternatively if the release date occurs in the future, it may be used to determine when to make a movie available for viewing on the set top box.

The <SCHEDULE_PERIOD> tag contains a date range inside which a movie or other content is scheduled to be on the set top box. The content may be on the box and viewable outside this range and may be removed inside this range, but this range should be used to aid in determining what content to delete.

Deleting Movies

The set top box must make room for new files by deleting less desirable files. In an exemplary embodiment of the present invention, determining when to delete a movie is done by calculating a number of variables. A score is calculated for each movie. On delete of a movie its associated data such as trailers, images, db entries, keys, video, audio, indexes, etc should also be deleted. There should be no net effect on total disk space used after movie arrival and deletion.

An “active movie” is a movie that has been purchased and is within its 24-hour window. The Arrival Date (AD) is the date/time when the set top box first recognizes a movie as a playable movie. The Keep Date (KD) is the time/date specified in the metadata (may be null) until which the movie may be kept. The Birth Date (BD) is the later of the two: begin view date, and arrival date. The Life Time Days (LTD) is the current age of a movie, or the number of days since its birth date.

An exemplary way to calculate the score is as follows:

Score=keep date(m) not null && keep date(m)>current date ? 100: grade value(m)/life time days(m)

A movie becomes unavailable when it's contract end date is passed, not when its end view date is passed. A movie is unrentable less than 24 hours prior to it's end contract date, so unless the movie is active, it is effectively not viewable. A non-viewable movie is assigned a negative score.

The result is that the following will have equivalent scores:

A movie 28 days old

B movie 14 days old

C movie 7 days old

All constants in these formulas should be easily changeable, presumably through the “config file”.

For movies with begin contract date in future: for example, a fully received movie with a begin contract date in future but is <1 month away should be kept (Score=100). A fully received movie with a begin contract date in future but is >1 month away should be deleted (Score=−1).

Movie news and Barker Channel content should each have low water and high water marks. Any Movie News or Barker Channel content that has passed its end contract period date should be deleted. Any Movie news or Barker Channel content that has passed its end SCHEDULE_PERIOD date should be deleted, unless total disk space used is below the low water mark. If total disk space used by Movie News or Barker Channel exceeds it's high water mark then Content with the lowest scheduled period should be deleted until disk space is below high water mark.

Metadata files should be locked while they are being used. If the file is upgraded while it is locked, and must be installed as soon as the file is released by its current user. For example through the user interface screen. The upgrades must be stored even if the currently use version of the metadata file is locked.

Types of Data

Trailer is this context refers to movie specific promotional material, delivered with movie. In the metadata XML, trailers are expressed in the TRAILER element. Trailers also have a contract begin date/time and contract end date/time. Trailer contract dates are not necessarily tied to contract dates of associated movie.

Trailers are all part of the same product—as represented by the Product Id, Item Id pair in the metadata. This product has a single key that generally should not be deleted. The Trailer product may be changed. The change is reflected by a new Product Id, Item Id pair in the metadata and will require a new key. The old key should be deleted once no trailers reference it.

Interstitial data is this context refers to content not delivered with a movie, which is intended for use, for example, in the Barker Channel. In the metadata, interstitials are expressed in the INTERSTITIAL element. Interstitial data may have contract begin date/time and contract end date/time. On delete of interstitial must also delete db entries, video, audio, indexes, etc. Net effect on total disk space used after movie arrival and deletion should be 0.

Interstitials are all part of the same product—as represented by the Product Id, Item Id pair in the metadata. This product has a single key that generally should not be deleted. The Interstitial product may be changed. The change is reflected by a new Product Id, Item Id pair in the metadata and will require a new key. The old key should be deleted once no interstitials reference it.

Movie Posters as well as actor and director images may, but generally will not, have contract begin date and contract end date.

The set top box may also receive free encrypted content, such as trailers and interstitials. Such content may be shown within the contract period without cost to the end user. Since the content is free BVD does not want plays of the free content to be included in the rental logs stored in the Smart Card.

‘Free Movies’ are all part of the same product—as represented by the Product Id, Item Id pair in the metadata. This product has a single key that generally should not be deleted. The Free Movie product may be changed. The change is reflected by a new Product Id, Item Id pair in the metadata and will require a new key. The old key should be deleted once no Free Movies reference it.

Payment

In a preferred embodiment of the present invention, a fee is charged to the user upon selection of the movie for viewing, a subsequent “rental confirmation” dialog and prior to viewing of the movie. In another embodiment of the present invention, the user is billed for viewing a movie once a substantial portion of the movie has been viewed. Once a movie has been selected, it can be viewed again without charge for a limited period of time (e.g. 24 hours), or for a limited number of viewings. In another embodiment, instead of paying for each movie, the user is charged a monthly fee. A modem and telephone line is used to indicate that a key is or has been sought by the user and thus a charge should be made. Thus, even though the user has a library of movies stored on the user's set-top box, there is no charge unless a movie is actually viewed.

User Interface

The first time the set top box is powered on, a tutorial is run that guides the user through the minimum necessary settings. A splash screen welcomes the user, and the tutorial engages directly. The user is prompted to enter his/her default menu language. After this has been set, the tutorial engages.

The user is prompted to answer a number of questions as the tutorial progresses. The user is welcomed and instructed that this is a basic setup tutorial, however any options set in the tutorial are possible to be reset later once the user gets to the main menu. The user is reassured that the setup tutorial may be replayed whenever the set top box is moved to a different location, or whenever the user should desire to have interactive help with some of the settings.

Next, the set top box attempts to dial out to the Phone Service Center. While this is happening, the tutorial lets the user know that it is trying to test the line. If the unit is unable to phone the Service Center successfully, it then prompts the user to set certain phone options. Next, it asks the user if there are any dialing prefixes that need to be entered. If the user answers “Yes”, it provides a screen to enter the numbers. If the user answers “No”, it moves on to the next possible option. Next, the user is asked if the phone line requires entering any call waiting cancellation digits. If the user answers “Yes”, it provides a screen to enter the numbers. If the user answers “No”, it moves on to the next possible option. Next, the user is asked if the phone line is tone or pulse. The default selection is “Tone”. The user either selects this, or Arrows over to “Pulse” and presses “Select”.

Once these options have been set, the Tutorial notifies the user that it is going to try again to phone the Service Center for the first time. If the attempt is not successful the user would be instructed to call Customer Service. Once the box has successfully placed a phone call to the Service Center, the user moves on to the next part of the Tutorial.

The antenna is now tested and set up.

Next, the tutorial tests the reception of the antenna. In this screen an animated graphic is seen along with audio feedback which provides visual and audio cues when signal is acceptable. Should the graphic animate that the signal is good, the user would proceed to the next step. If no signal is being received the UI might offer the following options. The user may be directed to a troubleshooting segment. If troubleshooting does not solve the problem, the user would be asked to call Customer Service. Once the antenna is successfully set up, the user is congratulated and taken to the main menu and may begin watching movies for the first time.

The user has the ability to replay the initial setup tutorial, at any time. It is preferably located under the Settings menu, as well as under the Help menu.

A Screen Saver is provided which automatically engages when there has been no activity, and no movie is playing, for a predetermined period of time, for example five minutes. If the user is watching a movie or a full screen video and pauses the video the Screen Saver will engage after a period of fifteen minutes non-activity. When Screen Saver is engaged, there is a message on the screen telling the user to “press any key to continue”. Pressing any key on the remote control or front panel (with the exception of “Power”) will disengage the Screen Saver once again.

Reboot

The set top box will need to reboot for various reasons. For example, should a new software download arrive, the box will reboot itself. Reboots can happen automatically while system is in standby (Power off). The system can also rebooted down by a command received from MovieBeam headquarters. This scenario does not result in any UI message. If the box needs to reboot while the user is watching a video or movie, the box will ask if it is okay to reboot. If the user selects “No”, s/he is prompted again later. (Specifics for timing and when the pop-up message would be allowed to come up again are TBD.) The user will only be able to reply “No” three times before the box is forced to reboot. If the user selects “OK”, the box will reboot and start up again automatically, taking the user back to the Main Menu. Should the box “watchdog” due to an internal error or otherwise need to reboot immediately, no UI will appear and a reboot will just happen. (Worst case scenario.) Should the box be unable to reboot by itself or through the UI, the user would need to unplug and plug in the box. (This would probably happen as the result of a call to Customer Service.)

Language Options

The user can select the language in which menus are displayed, from the choices of English, French and Spanish, a choice of one only Menu Language.

The user is able to set a default movie language, as well as to select up to three (the accuracy of this number is TBD) languages in which to store any movie (should that movie be available in that language). However, the user is warned that the more languages that are chosen, the fewer movies may be saved to the set top box due to limited hard disk space.

Parental Controls

This screen gives the user the option of setting the pass code, rating limit and/or a spending limit for the box. A rating or spending limit may not be set unless a pass code is already set. This screen also provides a quick summary of what the settings are set to, without needing to enter each screen individually for verification.

A screen is provided, from the Parental Controls Setup screen, which gives the user the ability to set his/her private pass code. If the user has never entered a pass code, the UI presents the user with a screen to force him/her to enter a pass code. It will also give the user another screen for verification of this pass code. If the pass code is correct the user may continue. If not, the user is prompted to try again. If a pass code has already been set, the UI presents the user instead with the screen to enter this pass code, giving him/her the option to Reset or Clear it. This screen also provides the user with a Help option, should s/he need assistance. Only one pass code per set top box is available. The user is asked to enter four digits XXXX. Numbers are entered either via a numeric keypad, alphanumeric keypad, or numbers mapped visually to certain keys on the remote control. The visual representation as keys are pressed is an asterisk at all times (to prevent children from seeing this code). Whether or not continuous incorrect entry is possible or not is TBD. The default passcode will always be “none”, unless set by the user. The user also has the ability to clear the passcode and return its setting to “none”.

Based on successful password entry, the user is then able to set rating limits. Ratings used (Phase One) are based upon the MPAA rating standard: G, PG, PG-13, R, with the addition of NR, for “Not Rated”. The default rating limit will always be “none”, unless set by the user. The user also has the ability to clear the rating limit and return its setting to “none”. In this screen the user is also given the ability to choose which rating “NR” should be aligned with when initiating the ratings lock. Once a limit is selected, the user must enter the pass code to initiate the limit. The user is then given a confirmation screen letting him/her know that the rating limit is now set, and that when the user begins to rent a movie, the pass code is required, as shown.

Once the pass code is set, the user will also be able to set a spending limit. The default spending limit will always be “none”, unless set by the user. The user also has the ability to clear the spending limit and return its setting to “none”. Entry is made via the number keys on the remote control and the user has the ability to set numbers up to $99.99. All amounts are in US dollars and cents. The user presses up and down to increase or decrease the number, and left and right arrows to go to the next number. Once a limit is selected, the user must enter his/her pass code to initiate the limit. The user is then given a confirmation screen letting him/her know that the rating limit is now set, and that when s/he begins to rent a movie, the pass code is required.

Television Type

The user is able to indicate the aspect ratio of the television screen connected to the set top box. The default selection is 4:3. If the user selects 16:9 widescreen then widescreen video content, will display without letterboxing. Likewise, if a 4:3 television is selected, then widescreen content will be displayed with letterboxing. The set top box includes a WSS signal in its video output to indicate to the TV the aspect ratio of the content being displayed.

Account Status

The Account Status screen shows the date the account was last updated and its next scheduled date to be updated. This screen would also provide the last successful phone call information. This screen is currently TBD and may not ultimately be implemented.

Rental History

A Rental History will be provided for up to n days, or for n number of rentals (current assumption is 45 rentals, but TBD), The objective of the rental history screen is to provide data for billing disputes and to monitor what others in the household are watching.

Clear Rental History

The user has the ability to clear the rental history, but if a passcode is set, s/he will need to enter that passcode to clear the history. Otherwise the user is asked to verify the action before its completion. Clearing the history in no way affects the same information contained on the box for the phone call to MovieBeam headquarters.

Diagnostic Screen

This screen will bring up all diagnostic information which might be necessary for troubleshooting a problem and would most likely be requested during a call to a Customer Service representative. For example, software version, last software download and status, set top box serial number, recording capacity, hard drive space used, hard drive space available, internal box temperature, dialing status (last phone call status/date/time), phone line status, Number of movies viewable, Number of movies deleted, and Copyright and trademark info. This is a text screen, therefore the user would need to Page Up or Page Down to view all the information, but none of the information is selectable.

The following section explains the most common operations and screens in the user interface.

Main Menu

Whenever the “Menu” button on the remote, or front panel, is accessed, the user sees the Main Menu screen. This is also the UI's default screen should any screen the UI is trying to access become unavailable.

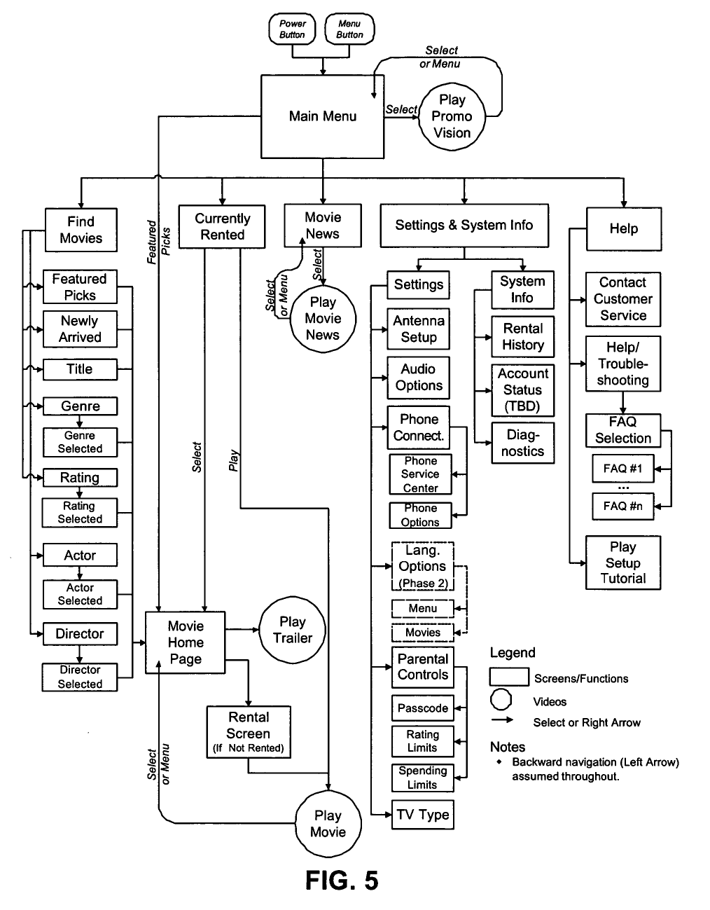

FIG. 5 is a flow diagram illustrating the flow of the user interface.

The Main Menu has a picture in picture window, on which information about the set top box features and movie trailers play. For example, movie trailers for movies that are currently stored on the set top box are displayed in this window. Other content may include system features, helpful hints, or non-critical system alerts. This information is updated periodically, for example, based on content. The window which frames the video may preferably be highlighted, and selected. Once selected, window expands to full screen view. Pressing any key on the remote control or front panel (with the exception of the “Play” controls) will minimize Screen once again and return the user to the Main Menu.

In one embodiment, “Movie News” is an option on the main menu. Once the menu item “Movie News” is selected, it takes the user to another screen with another inset window. This is considered the main Movie News page and offers video selections of Movie News. The user chooses either the name of the video to watch, or s/he may select the window which is currently playing the connected loops of video clips. Selection of video merely selects the video to see first. All videos are connected so that when one clip ends, the next begins. This loop is updated periodically.

If the Movie News is started from an inset window on the Movie News selection screen, pressing any key on the remote control or front panel (with the exception of the “Play” controls) minimizes the Movie News and returns the user to the Movie News selection screen. Play controls control the Movie News

At the top of the Main Menu is a Scrolling Marquee. The scrolling marquee is titled “Featured Picks” and displays a selection of featured movies. This selection of movies represents movies available in the box and the selection of these is made by the content provider. Featured Picks will be approximately ten to a dozen movies. It is represented by a series of selectable cover art of the movies in this category. When the box first arrives there will be about thirty (30) movies preloaded into it with a few marked then as Featured Picks.

Once Featured Picks is highlighted, each poster is also highlightable. The user navigates through the marquee with the left and right arrows. The highlight and the cover art thumbnails slide left and right smoothly. The highlight scrolls with the user's action upon the marquee. When the user stops scrolling, the marquee stops as well. When the cover art is selected the UI takes the user directly to that Movie's Home Page. If there are not enough movies in this section for the marquee to scroll, it will not. Also, if there are not enough movies to have Featured Picks, or if an error occurs with this feature, the Main Menu will compensate graphically (perhaps a standby graphic to take this place so the Main Menu doesn't “shift up” and change too much for consistency-sake).

The “Barker Channel” is the video programming that runs when the user is on the Main Menu. The Barker Channel is an important part of the user experience, since viewing it will often “bookend” a movie rental. Besides having an important functional role, the Barker Channel plays a very visible role in establishing the brand and “attitude” of the service.

The Barker Channel functions as a multipurpose communications area serving as a way to add ‘life’ to the interface, it is the primary means for promoting our content, and promoting the service.

The Barker Channel can be selected and run in full-screen mode by the user.

The Barker Channel is composed of many individual video clips that are assembled on the fly to form a “show” or “channel”. The Barker Channel rarely gets a chance to run for very long since it is only displayed on the top-menu page and the user often navigates away quickly. If allowed to run, the Barker channel should run for an hour or so before it starts to repeat itself.

The Barker Channel may want to start with a silent or quiet intro-segment to avoid a jarring audio experience whenever the user returns to the main menu.

Video Properties of the Barker Channel include:

4:3 Aspect Ratio

Displayed as an inset, “Picture-in-Picture” when minimized

Full screen when video area is selected

Video Segments always start at their beginnings. If you leave the main menu and return a new segment starts.

Independent segments must play back to back with no gaps.

Video Segments are all complete and properly formed MPEG files. Video segments start and end on GOP boundaries.

All “video transport” functions are supported. The “Next Chapter/Skip forward” button skips to the next segment. The “Previous Chapter/Skip backward” button skips to the beginning of the current segment, or to the previous segment when appropriate.

The Barker Channel displays video segments in a loop. Branding segments, such as short (2-8 second) branding messages may be part of the loop. Another example of the segments played on the Barker Channel include produced promotional material or longer form promotions, and produced segments. For instance, “Tips and Tricks”, or short segments showing ‘power user’ tips and tricks may be displayed. I.e. “Did you know that the page up and down keys will take you between movies on the list you're browsing?”

When a received movie is waiting for its start window to begin, it can be teased. Specific availability times can be used, since the movie is already stored locally. Some movies are teased well prior to their being available on the service. Specific availability dates or times should not be mentioned, since some users may not receive the movie prior to that date.

A trailer or series of trailers may be introduced or bracketed with a “bumper” or “bumpers”. For instance: “It's SCI-FI Week!” followed by a trailer for a SCI-FI film may be displayed. A specific trailer can therefore be preceded with an introduction for it.

Movie Trailers are short promotional segments, usually 1-2 minutes long. Trailers are typically available in both wide and 4:3 aspect ratios. We will use the 4:3 versions when available, and will convert wide-screen trailers to 4:3 by “letterboxing”.

Commercials may also be displayed on the barker channel.

Some segments that are called for in the Barker Channel play-list may not be available. The scripting system needs to allow for a group of segments to play only if the required segments are present. It would be an error to display the “SCI-FI promo” if it can't be followed by a movie in the “sci-fi” genre. Coping with this is one of the fundamental challenges of the Barker Channel.

In a potential situation where there is not enough content to create a Barker Channel experience (prolonged absence of signal can cause this), the Barker Channel should display built in clips which can loop without being too annoying.

When “powered off” by pressing the “Power” button on the front-panel or the remote-control, the Moviebeam set-top will pass-through the base-band video signal found on its input (if connected). When in this “powered off” mode, the Barker Channel should stop playing its loop. When the box is “powered on”, control will pass to the main menu and the Barker Channel should resume.

When scheduling clips to be played, it is preferred to avoid playing recently played clips. Some combination of random selection and “Least Recently Used” scheduling play an important part in creating the Barker Channel.

Currently Rented Movies

If the user has rented movies, the Main Menu shows an option for Currently Rented Movies. Otherwise, if there are no currently rented movies, this option does not appear as a menu item. If this item is there, and selected, the Currently Rented screen appears. This screen features a list of all movies that are currently rented. The screen has two columns: one column is the movie's Title and the second column is the Rental Time Remaining in hours and minutes. The movies which appear will always be sorted by time remaining, least time first. The Rental Time Remaining fields will all update simultaneously, once per minute. Movies which will expire in less then n hours (possibly six) will be indicated with red font, or some other standout color. If the user highlights a movie listed on this screen and then presses “Play”, that movie will immediately begin to play full screen. If the user highlights and then selects the movie, the UI will direct the user to that Movie's Home Page.

Searching

Another feature which is available from the main menu is the ability to search for movies using a number of different ways. The user is able to search for movies based on a number of different criteria. The user may search by featured picks, by title, newly arrived movies, by genre, rating, actor or actress, or director.

In a featured picks search, the list of these selected titles appear alphabetically and, if more than n entries, in a loop. The featured picks are also displayed on the scrolling marquee on the main menu. Selection of a movie title takes the user directly to the Movie's Home Page.

Search by title provides the user with a list of all available movies by title, appearing in alphabetical order so that they user may scroll through the list and easily locate the movie title they would like to view. Only titles of movies that are currently loaded in their entirety into the box appear in the list. This screen includes a movie poster and a brief description (Genre, Rating, Year, and Length) of the highlighted movie. Selection of the movie title takes the user directly to the Movie's Home Page. Once on the Movie Home Page within the “Find Movies: Title” search, the user may Page Up or Page Down to go to another Movie Home Page within this same searched category. Page Up and Page Down takes the user in a loop of the home pages in the search category. To exit the search the user presses the back (left) arrow.

The Newly Arrived Search provides a list of the movie titles most recently loaded into the box, appearing alphabetically and in a loop.

Genre Search provides a list of predefined genres appears alphabetically. Only movies that are currently loaded in their entirety into the box appear in the list. Once highlighted, a picture of either a movie poster of that genre or some other graphic will appear as well as titles of some of the movies in this category and/or the total count of how many movies of the selected genre currently reside in the box. Movies that are listed in more than one genre will appear in each. The exact list of genres would be updated with new software downloads as needed. Examples of genres include: Action, Adventure, Animation, Classics, Comedy, Drama, Family, Mystery, Romance, Science Fiction, Suspense, Thriller, and Westerns. Once the “Genre” is selected, the user would be directed to an alphabetical list of all the movie titles in this category.

A Rating Search provides a list of predefined (MPM) ratings, appearing alphabetically, from which the user can select a rating from the list. Once the “Rating” is selected, the user would be directed to an alphabetical list of movie titles. Only movies that are currently loaded in their entirety into the box will appear in the list. If a rating has a lock on it, then the icon for a locked out rating appears on this screen as well, next to the ratings which are “locked” by the pass code. The assumption currently is that ratings searches will be performed via simple searches. This is defined as a search ONLY upon the rating selected, not “equal to or less than” another rating.

Search by actor provides a list of actors and actresses. The list of actors' names preferably appears alphabetically, with last name first. This list should be presented in an alphabetical loop so that paging up or down will always take the user in a circle. If the actor (e.g., “Cher” or “Madonna”) has only one name, the UI compensates accordingly, eliminating the comma. This screen also preferably displays a photo of the actor and how many movies in which the actor is featured which currently reside on the box. If no picture of an actor is available, a still from one of the actor's movies will appear in the Photo slot instead. Once the actor's name is selected, the user would be directed to an alphabetical list of movie titles. This screen preferably includes a movie poster and a brief description (Genre, Rating, Year, and Length) of the highlighted movie.

A Search by director provides a list of directors' names, preferably appearing alphabetically, with last name first. If the director has only one name, the UI compensates accordingly, eliminating the comma. This screen presents the user with a photo of the director and how many movies by that director are currently in the box. If no picture of a director is available, a still from one of their movies will appear in the Photo slot instead. Once the director's name is selected, the user would be directed to an alphabetical list of movie titles. This screen includes a movie poster and a brief description (Genre, Rating, Year, and Length) of the highlighted movie.

Selection of a movie title in any of the searches takes the user directly to the Movie's Home Page. Once on the Movie Home Page within the “Find Movies, the user may Page Up or Page Down to go to another Movie Home Page within this same searched category. Page Up and Page Down takes the user in a loop of the home pages in the search category. To exit the search the user presses the back (left) arrow.

Movie Home Page

Once a movie title is selected (through any search method), the end of every search is always a Movie Home Page. This page displays the detailed information about a movie, such as Title, Year, Genre(s), Running Length, Director(s), Actors, Brief Synopsis, Trailer, Black & White or Colorized (Color is assumed), and Locked Icon (if rating limit applied), Rental Time Remaining (if rented), Subtitles (if applicable). The Movie Home Page may also include information such as rental price, available Languages (if available), and options for Wide Screen or Full Screen (if available).

Once the user accesses this page, the poster (or still from the film) of the movie comes up within the inset window for a few seconds (exact time TBD). After this time the poster goes away and is replaced by the trailer which engages automatically. In the Movie Home Page, the user has the choice of watching the Movie Trailer (which happens automatically, watching the Movie Trailer full screen, or renting the movie.

If the user selects the inset window when the Poster is there, it will engage the trailer full screen which will begin to play from the beginning; the trailer will only play through one time automatically per visit to the movie home page. If the user waits until the trailer begins in the window and then selects it, the video will playback in full screen mode. This is a looped video and will only stop with the Play controls available to the user. Stop will cause the video to return to the Movie Home Page. The user may use all other controls upon this video playback. Pressing any key on the remote control or front panel (with the exception of the “Play” control) minimizes the full screen trailer once again and return the user the Movie's Home Page.

Movie Expirations

If a user begins watching a movie with not enough time left on his/her rental to watch it the movie in its entirety, the user will receive a pop-up message warning her/him of the impending expiration.

Rented Movie

If the movie is rented the phrase “Watch Movie Now” on the Movie's Home Page changes to “Continue Watching Movie”. The Movie Home Page would also then display the rental time remaining. If a movie is rented it cannot be deleted from the box. The user shall always have twenty-four hours rental time.

Playback

Once rented, a user uses the basic remote control functions to play, pause, stop, fast forward, reverse, and skip (forward or back to another chapter) of a movie. Each time a Play control is pressed, a graphical positioning OSD pops up to show the user the current button pushed, and his/her current position within the movie.

Play begins playback of the rented movie (from either stopped and paused states). Hitting play from the Movie Home Page, or currently rented page, will resume playback of a rented movie.

Fast Forward Fast forwards playback of a rented movie. When the button is pressed once the video advances at greater than real time, and when pressed a second time, the video advances at an increased speed.

Reverse Reverses playback of a rented movie. Skip Forward Skips forward to next chapter marked within film, or to end or beginning of film if there are no more chapters, i.e., loops.

Skip Backward Skips back to previous chapter marked within film, or to beginning again if there are no previous chapters, i.e., loops. Slow Motion, although not a separate button, is a function available by pressing Pause, and then Fast Forward. Pushing Fast Forward once, advances the frames at n frames per second (FPS) and pressing Fast Forward twice, advances more quickly, at n FPS.

When a movie is stopped there is a smooth transition back to the Movie Home Page. If a movie is stopped somewhere mid-play (i.e., not end of movie), the “stop” flags where to resume the movie. “Play” would then resume a few seconds before the “stop” flag.

The Pause button pauses playback of a rented movie. When “Pause” is selected, the word “Pause” will appear on the OSD for a short period of time (probably a second or two, TBD), to alert the user that the movie has been paused. If a rented movie has been paused for longer than 15 minutes, the Screen Saver will engage. If a rating limit has been the passcode must be re-entered for the movie to play again. If no rating limit is set, the Screen Saver may be cancelled by hitting any key. Pressing pause again functions the same as Play, restarting the film at a normal Play rate.

User Interface Elements

All user interface is screens are 4:3 and fill the entire NTSC 4:3 frame. The user does not see drawing of the screen. A default selection will be highlighted when the user selects any screen. This is also referred to as the cursor or selection tool. The highlight moves around via the user's navigation with the arrow buttons, unless otherwise directed by the user interface. One example of an exception would be an information only text screen where the page up/down buttons scrolls the list, but no highlight or selection as possible. In such a case directions are presented to the user for navigation. Screen transitions from one screen to the next are designed to be smooth with no sudden flashes.

The user interface will attempt to return the user to its last highlighted location in a screen whenever possible. However due to indexing and updating of the database is this is not always possible. In such a case where the user interface unable to return the user to his last location within a screen, the user will be directed to the main menu.

Menu items consist of text entries, when selected, function as a radio button, whereby the selection nullify as any other possible selection. Menu items shall be at alphabetical in long lists and not necessarily so on short lists.

Lists containing more then a certain number of items are considered long, and may be presented as scrolling lists. These will be displayed with arrows at the top and bottom of the list display area. Scrolling lists are preferably arranged in a continuous loop, with the first listing displayed below the last listing. The last entries displayed above the first entry. When the highlight moves the top of the list, pressing the up button causes the highlight to stay at the top and the Texas roll down behind it. When the highlight is in the center area, behaves normally by moving up and down the screen. When the highlight is at the bottom of the list, pressing down the down button causes the highlight to stay at the bottom and the text will roll up behind it. If the remote control has a numeric keypad numbers are used as alphabetical shortcuts to the first letter of the titles earnings. If the remote control has a numeric keypad, keypad has letters printed above or on the button as a telephone.

Lists containing a certain number of items or less are considered short lists. Short lists are displayed centered vertically on the screen to reduce the amount of buying screen space. The highlight has Carousel behavior. Pressing arrow down from the last list item will move the highlight to the first item.

The user interface allows for scrolling. Scrolling allows smooth movement at a pre-determined rate. Scrolling Marquee thumbnails move smoothly at a pre-determined rate.

Video Images/Graphics

Still images may exist on any screen of user interface. Specifically, they exist on the main menu page, any help movie homepage, and the find movies page. Such images include: movie posters, actor and director photos.

Text windows occur whenever there are messages for the user, such as in the rental history screen, where text is viewed that is not possible to highlight or select anything. On screen displays (OSDs) appear in front of any video when one of the following controls is engaged: play, pods, fast-forward, skip, reverse, stop. A position bar will also appear as in on screen display when any of the above are engaged (except player stop) to give the user or visual representation of his or her position within a movie. The on screen display appears for a few seconds and then disappears off the screen.

Pop-up messages are reserved for error, warning and verification messages. Should an unexpected error occur the user is notified via message which pops up, using as little of the screen at areas possible. When these messages appear at the surrounding area is partially transparent, enabling users always know his or her position in the user interface. The user always has the ability to exit the message. For example an OK or cancel command will be presented to the user.

Audio feedback exists for any selection made by the user. If it is a valid and successful selection, the feedback is a positive response sound (click). An invalid key press results in a negative response sound. (bonk)

Software Upgrades

All software components in the system must be field upgradeable. The software image for the upgrade process is downloaded as compressed .tar files via datacast or through a modem telephone call. The following software elements must be field upgradeable.

1. Single executable software build that includes application software, network interface library, hardware device drivers, etc

2. User Interface configuration files that drive the positioning of graphics widgets on the screen.

Three versions of application software images must be retained in the read only partition of the hard drive during a software download. These include the software image that is currently being executed on the set top box, the last known good image of the software (one revision back from the one currently being executed), and the latest software image downloaded to the set top box that is yet to be installed.

The set top box must roll back to the last known good version of the software image if it detects a critical number of watchdog instigated resets. This requires the data associated with the application software (data driven software) to be backward-compatible with the previous version of the software image.

The client should be able to incrementally update the application image via the data images. This upgrade must not introduce new software functionality and must be used solely for updating user interface look and feel and system configuration. For example, help files are part of application that can be upgraded independent of that location software.

Alternative Embodiments

In an alternative embodiment, media content is delivered from a content provider to the set top box through Internet based communication methods, based on a predetermined set of constraints, prior to viewing the media. An asset list comprises information related to the media assets, or content to be downloaded to the set top box, and is transmitted from the content provider to the set top box. The asset list, for example contains URL's or information related to the location of the media assets.

A client asset manager process resides in the set top box and is responsible for downloading assets from the content provider. The asset manager uses the asset list to request media assets which are located at a remote site. The client process manages delivery of assets to the user device, periodically, when specific constraints are met. For example, movies are delivered to the user when there is optimal network bandwidth availability, user device memory, assured quality of service, etc.

The present invention furthermore provides improved methods for delivering one or more large media assets, for instance, audio content, video content, movies, games etc., intelligently and adaptively, over a network to a local asset store. As such, the local asset store is available to a client, or end-user, device and where a relatively high quality of service is to be assured. The invention also includes an adaptive method of combining these assets into an essentially seamless presentation based on local availability of the assets.

In this alternative embodiment, the present invention comprises a method for delivering an asset over a network. The method comprises supplying an asset list over the network to a user device. The method further comprises a client which operates on a user device such as a set top box. The client refers to the asset list in downloading and delivering the asset to the user device. The client further manages downloading the assets based on when at least one predetermined constraint is satisfied.

A content provider can place a digital asset on a user's device a priori, so that it is immediately available for use, without a network download, when the user needs it. This can happen when explicitly requested by a user or process, or be initiated by a content provider based on a subscription service.

Home Music Library

In yet another embodiment, the system and method of the present invention is used to provide an at home digital music library. In such an embodiment, audio data is transmitted to a hardware device. For example, newly released CD's, singles, or other audio is transmitted to a user's device. As described above, data is preferably transmitted wirelessly through datacasting, or by encoding data onto standard broadcast television and radio waves, however data can also be transmitted through more conventional methods such as broadband Internet connections via telephone lines, satellite, or cable.

In accordance with the present invention, a content provider transmits a plurality of newly released CDs as digital audio files. A hardware device in accordance with the present invention accumulates the music transmitted to it and stores it on its hard drive or other memory. The user is then able to choose from a large selection of up to date music choices, similar to what one might find at a record store.

The hardware device in accordance with the present invention may be a portable device, an at home stereo component, or an in car receiver. For example, the hardware device can be a portable music device such as an mp3 player or other digital audio player also comprising communication means for receiving data that is broadcast to it. The hardware device could be an at home stereo component for providing an at home or office music library. The hardware device could also be built into a car stereo system.

The user may be given the choice to rent the music for a limited time, or may be given the choice to purchase the selection and then granted privileges to record to other media or may be granted full access to all music as long a subscription fee is paid. When music is purchased, the hardware device may also include a CD burner such that the audio files can be recorded to a CD. Alternatively, the hardware device may have some other type of removable media such that the music can be listened to in other places/devices.

Descriptions of exemplary embodiments of the invention provided are open form of implementation. Other embodiments and implementation may be utilized and structural and functional changes may be made without departing from the respective scope of the present invention. The attached description of exemplary and anticipated embodiments of the invention have been presented for the purposes of illustration and description. They are not intended to be exhaustive or to limit the invention to the precise forms disclosed.

Many modifications and variations are possible in light of the teachings herein. Many other forms of the invention exist, each differing from the others in matters of detail only. The invention is to be determined by the following claims.

We claim:

1. A method of broadcasting a movie to a set-top box, the method comprising:
a content provider broadcasting via wireless telecommunication over a television frequency spectrum at least one movie to a set-top box, the movie being selected by the content provider and not by the user; and
permitting storage of the movie broadcast from the content provider in the set-top box without interaction by the user.

2. The method of claim 1 further comprising the step of permitting indicating that the movie is available for viewing once the entire movie has been received on the set top box; and
permitting viewing of said movie by a user.

3. The method of claim 1 further comprising the step of re-broadcasting movie data previously broadcast to ensure that the entire movie is received by the set-top box.

4. A method of broadcasting a movie to a set-top box, the method comprising:
a content provider broadcasting movie data to a set-top box, the content of the movie data being selected by the content provider;
permitting automatic storage of the movie data broadcast from the content provider onto the set-top box;
permitting assembling the movie data in the set top box to form at least one full movie and associated metadata;
permitting analysis of the metadata to determine when to make the movie available for viewing; and
permitting viewing of the movie in response to a user's selection of the movie.

5. The method of claim 4 wherein permitting viewing occurs upon agreement to charge the user a fee for viewing the selected movie.

6. The method of claim 4 wherein associated metadata comprises information such as time stamps which determine begin and end dates for permitted movie viewing.

7. The method of claim 4 wherein the movie selected by the user is available for viewing for a limited period of time.

8. The method of claim 4 wherein the movie selected is available for viewing for a limited number of times.

9. The method of claim 4 comprising the step of repeatedly re-broadcasting movie data thereby to ensure that the entire movie is received by the set-top box.

10. A method of broadcasting movies to a set-top box, the method comprising:
a content provider broadcasting movie data to a set-top box, the content of the movie data being selected by the content provider and not by the user;
permitting automatic storage on the set-top box of the movie data broadcast from the content provider;
permitting assembly of the movie data to form a plurality of full movies;
making selected movies available for viewing by the user at a time pre-determined by the content provider, the selected movie having previously been stored on the set top box; and
effecting removal of the movie data representing one or more movies stored on the set top box at a time determined by the content provider.

11. The method of claim 10 wherein the movie data is transmitted and stored to the set top box at a time being at least one day, and preferably about a week, before making the movie available for viewing.

12. The method of claim 10 wherein the movie data comprises audio and video to form a movie and associated metadata, wherein the metadata indicates the time predetermined by the content provider to make the movie available for viewing by the user.

13. The method of claim 12 wherein the movie is a new release and the time predetermined by the content provider to permit viewing by a use is an official release date for the new release.

14. The method of claim 10 wherein movie data is broadcast to the set-top box using standard file transfer protocols.

15. The method of claim 10 further comprising the step of repeatedly re-broadcasting movie data thereby to ensure that the entire movie is received by the set-top box.

16. The method of claim 10 wherein a movie is made available for viewing by the user upon payment of a fee.

17. A method of broadcasting a movie to a set-top box, the method comprising:
a content provider broadcasting movie data to a set-top box, the content of the movie data being selected by the content provider; and
permitting automatic storage of the movie data broadcast from the content provider onto the set-top box.

18. A method of broadcasting movies to a set-top box for storage and subsequent viewing, the method comprising the steps of:
selectively broadcasting data wirelessly from a content provider to a set-top box;
remotely controlling when to make data available for viewing by the user; and
remotely controlling when to remove data from the set-top box.

19. The method of claim 18 including permitting the user to select when to view selected data during an available access time, the user selectively viewing the data on one or more television sets, and the set top box being a unit separate from the one or more television set.

20. The method of claim 18 wherein payment for a permitted viewing of the data is made by the user through a separate telephone line.

21. The method of claim 18 wherein selectively broadcasting data permits the content provider to determine the data to be broadcast wirelessly to the set-top box.

22. The method of claim 18 wherein data is broadcast by encoding data onto standard broadcast television signals.

23. A method of content management for a remote hardware device, the method comprising the steps of:
collecting content to be transmitted to a remote hardware device;
generating metadata specifying various properties of the content;
associating the metadata with the content;
transmitting the content and its associated metadata to the remote device;
permitting automatic storage of the data received at the remote device;
providing software for operating on the remote hardware device to process the metadata and manage the content according to its associated metadata.

24. The method of claim 23 wherein the metadata comprises information indicating when to make content available to the viewer and when to remove content from the hardware device.

25. The method of claims 18 herein comprising the step of repeatedly re-broadcasting movie data thereby to ensure that the entire movie is received by the set-top box.

26. A method of providing movies available for purchase or rental directly to remote viewers through broadcast communication, the method comprising:
providing a viewer with a set top box, the set top box having a hard drive for storing a plurality of movies;
broadcasting movie data to the set top box and allowing movie data to accumulate on the hard drive; and
providing software resident on the set top box, the software being programmed to:
automatically store the movie data broadcast to the set top box;
assemble the movie data into a plurality of viewable movies and associated metadata;
analyze the metadata to determine when a movie should be made available; and
allow the user to select the available movie when available.

27. A method as claimed in claim 26 wherein the movies are available fro a predetermined limited time and thereafter are essentially removed by the broadcaster.

28. A method as claimed in claim 26 wherein the movies are encrypted thereby to limit the availability in at least one of the following respects, being copied multiple times, being viewed more than once, or being viewed or copied other than when predetermined criteria are met.

29. A method as claimed in claim 26 wherein the movie is broadcast by encoding data representative of the movie onto standard broadcast television signals.

30. A method of creating a digital home movie library, the method comprising the steps of:
having a content provider broadcast movie data to a plurality of set-top boxes, the content of the movie data being selected by the content provider and being uncontrolled by the user;
automatically storing on the set-top box the movie data broadcast from the content provider;
assembling the movie data to form a plurality of full movies; and
making one or more of the movies available to the user at a time predetermined by the content provider.

31. A method as claimed in claim 30 wherein the movies are available fro a predetermined limited time and thereafter are essentially removed by the broadcaster.

32. A method as claimed in claim 30 wherein the movies are encrypted thereby to limit the availability in at least one of the following respects, being copied multiple times, being viewed more than once, or being viewed or copied other than when predetermined criteria are met.

33. A method as claimed in claim 30 wherein the movie is broadcast by encoding data representative of the movie onto standard broadcast television signals.

34. The method of claim 26 wherein payment for the data is made through a separate telephone line.

35. The method of claim 30 wherein selectively broadcasting comprises the content provider determining what data is broadcast wirelessly to the set-top box.

36. A method of providing a dynamic media library to a set-top box, the method comprising:
having a content provider broadcasting media data to a plurality of set-top boxes, the content of the data being selected by the content provider and not being selected by the user;
automatically storing the media data broadcast from the content provider on the set-top box; and
providing a user interface for the user to browse the media library.

37. A method of distributing movies directly to viewers at home comprising:
providing a viewer with a set top box, the set top box having a hard drive for storing a plurality of movies and software for permitting access to the movies;
broadcasting at least one movie and associated data to the set top box wirelessly prior to an official release date for the movie, the associated data regulating the release date of the movie on the set top box; and
automatically storing the movies and its associated data to the set top box hard drive;
analyzing the associated data to determine when the movies should be made available for viewing; and
permitting viewing of the movie on its release date.

38. A method of renting a movie to a remote user, the method comprising the steps of:
transmitting electronically a plurality of movies to a set top box located with the user, the movies comprising a selection of movies essentially similar to hard copies of movies at a local movie rental store;
automatically storing the electronic form of the broadcast plurality of movies on the set top box;
permitting the user to select from the plurality of stored electronic movies, at least one of the movies for viewing; and
charging a fee to view the one of the plurality of movies.

39. The method of claim 38 whereby the step of transmitting comprises wirelessly broadcasting the movies through a datacast television broadcast system.

40. The method of claim 38 whereby the step of transmitting comprises transmitting via the Internet.

41. A digital home movie library system for providing access to movies comprises:
an antenna and tuner for receiving broadcast signals;
a hard disk drive for storing movie data transmitted by the broadcast signals and received through the antenna; and
a processor for executing software, processing data received through the antenna and tuner, and for processing user input commands to permit access to the stored movie data under predetermined control conditions.

42. A digital home movie library as claimed in claim 41 including a modem to permit electronic billing of the user for access of the library.

43. A system for providing access to movies comprising:
an antenna and receiver for receiving broadcast signals;
a processor for executing software, processing data received through the antenna and tuner, and for processing user input commands to permit access to the stored movie data under predetermined control conditions;
a hard disk drive for storing movie data transmitted by the broadcast signals and received through the antenna; and
a smart card secured to a circuit board of the receiver, the smart card facilitating a dedicated use of the receiver with a designated user.

44. A system as claimed in claim 43 including a modem to permit electronic billing of the user for access to the movies in the hard drive storage.

45. A system of claim 43 wherein the receiver and antenna form part of a set top box for operation with a monitor.

46. A system of claim 43 wherein the receiver and antenna form part of a set top box, and including an integral fastening of an active component of a smart card to a circuit board of the set top box thereby to impede removal, and enhance the security of the set top box

47. The system of claim 43 including a secondary external smart card slot for use with another smart card in case the system becomes compromised.

48. The system of claim 46 wherein the smart card is fastened to a main board of the set top box with epoxy.

49. A method of a remote user receiving and processing a broadcast of a movie to a set-top box, the method comprising:
receiving through an antenna a content provider broadcasting via wireless telecommunication over a television frequency spectrum of at least one movie, the movie being selected by the content provider and not by the remote user; and
storing of the movie broadcast from the content provider in a set-top box without interaction by the user.

50. The method of claim 48 further comprising the step of indicating to the user that the movie is available for viewing once the entire movie has been received on the set top box; and
permitting viewing of said movie by a user.

51. The method of claim 48 further comprising the step receiving a re-broadcasting of movie data previously broadcast to ensure that the entire movie is received by the set-top box.

52. A method of a remote user receiving a movie broadcast to a set-top box, the method comprising:
receiving movie data broadcast by a content provider to a set-top box of a user, the content of the movie data being selected by the content provider;
storing of the movie data broadcast from the content provider onto the set-top box;
assembling the movie data in the set top box to form at least one full movie and associated metadata;
analyzing of the metadata to determine when to make the movie available for viewing; and
viewing of the movie in response to the remote user's selection of the movie.

53. The method of claim 51 wherein viewing occurs upon agreement to charge the user a fee for viewing the selected movie.

54. The method of claim 48 wherein the movie selected by the user is available for viewing for a limited period of time.

55. The method of claim 51 wherein the movie selected is available for viewing for a limited number of times.

56. A method of a remote user receiving a broadcast movies to a set-top box, the method comprising:
receiving from a content provider movie data broadcast to a set-top box, the content of the movie data being selected by the content provider and not by the remote user;
automatically storing on the set-top box the movie data broadcast from the content provider;
assembling of the movie data to form a plurality of full movies;
selecting movies for viewing by the user at a time pre-determined by the content provider, the selected movie having previously been stored on the set top box; and
permitting removal of the movie data representing one or more movies stored on the set top box at a time determined by the content provider.

57. The method of claim 55 further comprising the step of repeatedly receiving rebroadcast movie data thereby to ensure that the entire movie is stored by the set-top box.

58. The method of claim 55 wherein a movie is made available for viewing by the user upon payment of a fee.

59. A method of receiving a broadcast a movie on a set-top box of a remote user, the method comprising:
receiving a broadcast movie from a content provider broadcasting movie data to a set-top box, the content of the movie data being selected by the content provider; and
storing for a predetermined time on the set top box the movie data broadcast from the content provider onto the set-top box, the predetermined time being established by the content provider.

60. A method of permitting a remote user to view a showcasing of the contents of a digital movie library, the method comprising the steps of:
providing a user interface comprising a scrolling marquee and a window, whereby the scrolling marquee features a plurality of images, each image representing a movie, and the window contains a video loop, comprising trailers for movies; and
permitting the user to view the interface.

61. A method of claim 59 wherein the remote user receives and processes a broadcast of a movie to a set-top box, the method comprising:
receiving through an antenna a content provider broadcasting via wireless telecommunication over a television frequency spectrum of at least one movie, the movie being selected by the content provider and not by the remote user; and
storing of the movie broadcast from the content provider in a set-top box without interaction by the user.

62. The method of claim 60 wherein viewing occurs upon agreement to charge the user a fee for viewing the selected movie.

63. The method of claim 61 wherein the movie selected by the user is available for viewing for a limited period of time.

64. A method of broadcasting designated audio content to a hardware device, the method comprising:
a content provider broadcasting via wireless telecommunication over a designated frequency spectrum at least one audio to a hardware device, the designated audio content being selected by the content provider and not by the user; and
permitting storage of the designated audio content broadcast from the content provider in the hardware device without interaction by the user.

65. The method of claim 63 further comprising the step of indicating that the designated audio content is available once the entire designated audio content has been received on the hardware device; and
permitting access to said designated audio content by a user.

66. The method of claim 63 further comprising the step of re-broadcasting designated audio content data previously broadcast to ensure that the entire designated audio content is received by the hardware device.

67. A method of broadcasting a designated audio content to a set-top box, the method comprising:
a content provider broadcasting designated audio content data to a hardware device, the content of the designated audio content data being selected by the content provider;
permitting automatic storage of the designated audio content data broadcast from the content provider onto the hardware device;
permitting assembling the designated audio content data in the hardware device to form at least one full designated audio content and associated metadata;
permitting analysis of the metadata to determine when to make the designated audio content available; and
permitting access to the designated audio content in response to a user's selection of the designated audio content.

68. The method of claim 66 wherein permitting access occurs upon agreement to charge the user a fee for viewing the selected designated audio content.

69. A method of broadcasting a designated video content to a set-top box, the method comprising:
a content provider broadcasting via wireless telecommunication over a television frequency spectrum at least one video to a set-top box, the video being selected by the content provider and not by the user; and
permitting storage of the video broadcast from the content provider in the set-top box without interaction by the user.

70. The method of claim 68 further comprising the step of permitting indicating that the video is available for viewing once the entire video has been received on the set top box; and
permitting viewing of said video by a user.

71. The method of claim 68 further comprising the step of re-broadcasting video data previously broadcast to ensure that the entire video is received by the set-top box.

72. A method of broadcasting a video to a set-top box, the method comprising:
a content provider broadcasting video data to a set-top box, the content of the video data being selected by the content provider;
permitting automatic storage of the video data broadcast from the content provider onto the set-top box;
permitting assembling the video data in the set top box to form at least one full video and associated metadata;
permitting analysis of the metadata to determine when to make the video available for viewing; and
permitting viewing of the video in response to a user's selection of the video.

73. The method of claim 71 wherein permitting viewing occurs upon agreement to charge the user a fee for viewing the selected video.

74. The method of claim 71 wherein the video selected by the user is available for viewing for a limited period of time.

75. The method of claim 71 comprising the step of repeatedly re-broadcasting video data thereby to ensure that the entire video is received by the set-top box.

76. A system as claimed in claim 41 wherein the set-top box includes a modem, and wherein the set-top includes software to periodical permit contact with the content provider through the modem.

77. A system as claimed in claim 75 information passed between the content provider and the set-top via the modem includes at least one of a user's viewing/rental history, access information used for billing purposes, set-top performance logs to monitor the performance of the system or keys used to decrypt videos.

78. A system as claimed in claim 75 wherein the processor simultaneously plays a video and reacts to signals from a remote control, and modem activity.

79. A system as claimed in claim 75 wherein the hard drive is physically mated with the set-top box structure for security purposes thereby rendering it useless for its intended storage purpose if removed for intended use apart from the set top box.

80. A method of broadcasting movies to a set-top box for storage and subsequent viewing as claimed in claim 18 wherein videos stored on the set top box are encrypted, and upon selection of a video to view and satisfaction of business rules, the set top box permits the video to be decrypted and played.

81. A method of broadcasting movies to a set-top box for storage and subsequent viewing as claimed in claim 18 wherein the set-top box is not necessarily connected to the content provider after the video is stored, and prior to allowing a video to be viewed, the video being capable of independent decryption by electronic keys on the set-top box along with the current account status.

82. A method of broadcasting movies to a set-top box for storage and subsequent viewing as claimed in claim 18 including logging a decryption of a movie and using this log to determine a user's bill.
